(19) United States
(12) Patent Application Publication
(10) Pub. No.: US 2022/0245684 A1
(43) Pub. Date: Aug. 4, 2022

(54) POINT OF DONATION LENDING SYSTEM AND METHOD FOR FACILITATING CHARITABLE DONATIONS

(71) Applicant: U-Pledge Inc., Los Angeles, CA (US)

(72) Inventor: Dominic KALMS, Los Angeles, CA (US)

(21) Appl. No.: 17/592,304

(22) Filed: Feb. 3, 2022

Related U.S. Application Data
(60) Provisional application No. 63/145,707, filed on Feb. 4, 2021.

(51) Int. Cl. G06Q 30/02; G06Q 20/40; G06Q 20/06; G06Q 40/02

(52) U.S. Cl. CPC G06Q 30/0279; G06Q 20/4014; G06Q 40/025; G06Q 20/065; G06Q 20/4016

(57) ABSTRACT

A point of donation lending system for facilitating charitable donations is disclosed. The system provides essential funds to non-profit organizations for helping the poor, needy, hungry, and disadvantaged worldwide. The plurality of modules comprises an NPO registration module, configured to register one or more organization via a plurality of organization details for implementing a donation feature. The plurality of modules further comprises a donation integration module, configured to create a donation page of each of one or more registered organization for a donor to pay. Further, the created donation page is integrated with the system for the donor access. The system facilitates integration of loan facilities for donations via a donor registration module. The plurality of modules enables the donor to track the loan payment, whereby on loan approval the third-party loan provider organization directly transfer the loan to the chosen NPOs.

### CROSS-REFERENCE

This application claims the benefit of U.S. Provisional Application No. 63/145,707, filed Feb. 4, 2021, which is hereby incorporated by reference in its entirety, and for all purposes, herein.

### BACKGROUND

Many non-profit organizations, or “NPOs,” improve society by providing help and support to those in need. Such non-profit organizations rely heavily on volunteers to raise donations from friends and families. Some non-profit organization causes are highly defined and visible, and some might not be that visible. Such less visible or small non-profit organizations do not have the resources to engage in large scale fundraising or advertising efforts. They do not obtain the benefits available to large organizations such as the Red Cross, the Salvation Army, and the like.

### SUMMARY

This summary is provided to introduce a selection of concepts, which are further described in the detailed description of the disclosure. This summary is neither intended to identify key or essential inventive concepts of the subject matter nor to determine the scope of the disclosure.

All non-profit organizations (NPOs) require large amounts of donations from time to time for giving out help to the causes for which they are working. However, even if individuals support the cause they may not have the funds to make their desired donations. Hence, there is a need for an improved system for facilitating charitable donations with loan features and a method to operate the same and therefore address the aforementioned issues. An effective system should be available to help the charitable donors with loan facilities, where they can donate a larger amount to any NPO at any time. Such a system would allow NPOs to support their causes without running out of funds or needing to shut down.

Various embodiments of the present disclosure help NPOs with their desperate need for more money by boosting donations. The system helps the NPOs with cashflow by converting payments over time into immediate upfront donations, and increases satisfaction of donor, as they can provide greater help immediately to a cause they support.

Embodiments of the present disclosure relate to the field of fundraising, and more particularly to a system and a method for facilitating charitable donations with a loan. The systems and methods described herein provide a credit product to serve the half a trillion dollar donor market, which allows donors to “Give Now, Pay Later.” The “Point of Donation Loan” (PoDL) employed herein, like a PoS (Point of Sale) loan, enables a donor to finance their donation to increase its monetary impact. In some embodiments, the loans are interest free, over a period of time. In some embodiments, the loans do not require a down payment. Importantly, the donor gets the full tax deduction right away and the nonprofit receives the full funds immediately but the donor does not come out of pocket any money at the point of donation. This solves the liquidity problem for the nonprofit, gives the donor the full tax benefit, and creates a new customer for the lender.

In some embodiments, the methods and systems herein provide modalities for both One-Time Donations and Recurring Donations. In some embodiments, the methods and systems herein are integrated on a non-profit organization's (NPO) websites through one or more of:
direct integration such as with a front-end code button;
overlay widget;
virtual card;
API integration with a third-party donor management platform such as, by way of non-limiting examples, Classy and Blackbaud;
API integration with a third-party payment processing platform such as, by way of non-limiting example, PayPal, QGive, DonorBox, and Fundly; and
API integration with a third-party crowdfunding platform such as, by way of non-limiting examples, GoFundMe, Indiegogo, and Crowdrise.

In some embodiments, during checkout a donor is given an option to “give now and pay later” (GNPL) if they increase their donation above an intended donation amount (i.e., their original baseline donation). Once a series of datum (e.g., SSN, Name, Address, etc.) is received, an underwriting process, such as soft credit pull, database checks, and compliance measures (e.g., KYC, AML, etc.) is performed. In some embodiments, a donor that passes the underwriting process selects from a series of financing options for their donation (e.g., various loan lengths and amounts paid per month) based on an overall credit limit for which they are now eligible to donate (e.g., $100 to $15,000). The donor is further able to select a maximum donation. In some embodiments, if the loan is accepted the donor can elect a payback duration (e.g., 3, 6, 9, or 12 months) and a first payment date (e.g., 30 days).

The donor will then be redirected back to the nonprofit's website to complete the transaction. In some embodiments, the transaction, including donor information, is then fed to the nonprofit's CRM to trigger the tax deductible receipt to be sent to the donor from the nonprofit. In some embodiments, if the donor is rejected for the loan, they are sent back to the nonprofit's site to make a normal one time donation if they still wish using the nonprofit's traditional payment processor. In some embodiments, if the donor is accepted for the loan but does not choose to take the loan, they will be redirected to the nonprofit's site to make a normal one time donation if they still wish using the nonprofit's traditional payment processor.

In some embodiments, the door receives reminders and/or messages with the account created at the point of loan acceptance. In some embodiments, payment receipt, processing, ledger maintenance, and distribution is performed by the systems and methods herein, we also keep the general ledger of the loan. After the donor accepts the loan and completes checkout on the nonprofit's website, the loan is initiated by our third-party lending partner (e.g., bank). They send information on the loan details to us for our servicing record. The bank also uses our underwriting information to derive an imputed interest rate which is charged as a one-time fee to the nonprofit. The donor pays zero interest on the loan. The bank withdraws its interest fee on the loan (ranging from 12-20%) prior to sending the proceeds of the loan to the nonprofit institution. The bank may then hold the loan on their balance sheet or sell it in whole or in part to a third-party “flow forward” partner.

In some embodiments, the NPO receives the net proceeds of the loan in their account and receive a tax donation letter. In some embodiments, for recurring donations, the donor requests a monthly recurring donation “pledge” into a contractual promissory note with a lending institution. In some embodiments, the nonprofit receives the full balance of the annualized donation immediately, while the donor still pays it back in installments month-to-month. In some embodiments, perpetual donors for perpetuity receive calendar notifications regarding yearly underwriting processes, and approvals. The donor can also opt-out at this time. In some embodiments, the methods and systems herein work across any point of donation such as online, gala tickets, street teams, and auctions.

Accordingly, in one aspect, disclosed herein are computer-implemented systems for donating to a charitable non-profit organization (NPO), the system comprising: a digital processing device comprising: at least one processor, an operating system configured to perform executable instructions, a memory, and a computer program including instructions executable by the digital processing device to create an application comprising: an NPO registration module receiving a plurality of details of the NPO; a donation integration module creating a donation page accessible by the NPO to receive a donation; a donor registration module receiving an application for a loan to donate to the NPO; and a loan tracking module, providing a loan notification to the donor. In various embodiments, the plurality of details comprises an organization name, an organization working domain, an organization slogan, or any combination thereof. In various embodiments, the donation page comprises a name of the NPO, a working domain of the NPO, a slogan of the NPO, a detail of the NPO, or any combination thereof. In various embodiments, the application for the loan comprises a donation amount, donation plan selection, a personal data of the donor, a payment information, a payment type, a two-factor donor authentication, or any combination thereof. In some embodiments, the application further comprises a module transmitting data between the donation integration module and the donor registration module. In some embodiments, the donor registration module further verifies an identification of the donor. In various embodiments, the loan notification comprises a notification of loan payment, loan approval, loan rejection, fund transfers, tax donation receipts, or any combination thereof. In some embodiments, the loan tracking module further provides the loan notification to the NPO. In further embodiments, the loan tracking module further tokenizes the loan notification, and sends the tokenized notification to the NPO. In some embodiments, the loan tracking module further transmits the donor information, a parameter of the loan, or both to a system of record.

In another aspect, disclosed herein are computer-implemented methods of comprising: receiving, from a donor, a donor information and a donation amount to a non-profit organization (NPO); performing, by an integrated decision engine, a fraud and credit risk assessment, wherein: if the fraud and credit risk assessment is declined: transmitting a notification to the donor of the fraud and credit risk assessment decline; directing the donor to an NPO donation form; and appending the fraud and credit risk assessment decline to the donor information; and if the fraud and credit risk assessment is approved: transmitting a notification to the donor of the fraud and credit risk assessment approval; transmitting, to the donor receiving the fraud and credit risk assessment approval, a loan plan; generating an approved loan based upon the loan plan upon receipt of the donor's approval of the loan plan; and transmitting the donor information and the approved loan, to a system of record. In various embodiments, the donor information comprises a donation amount, donation plan selection, a personal data, a payment information, a payment type, a two-factor donor authentication, or any combination thereof. In some embodiments, the method further comprises transmitting a notification to the NPO based on the loan. In some embodiments, the method further comprises providing a verification code to the donor and receiving the verification code from the donor to validate the donor. In some embodiments, the method further comprises requesting, by the system of record, a fund from a lender denoted in the approved loan plan; receiving, by the system of record, a current status of the approved loan plan from the lender; or both. In some embodiments, the method further comprises providing the loan plan amount to the NPO. In some embodiments, the method further comprises tokenizing the donor information, the approved loan, or both before transmitting the donor information and the approved loan to a system of record, and wherein the tokenized donor information, the tokenized approved loan, or both are sent to the system of record. In some embodiments, the method further comprises: receiving, from the donor, a rejection of the loan plan; and transmitting, to the donor, an alternative loan plan, wherein if: the donor approves the alternative loan plan, the approved loan is generated based on the alternative loan plan; and the donor rejects the alternative loan plan, directing the donor to an NPO donation form.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a first portion of an exemplary flow diagram for facilitating charitable donations, in accordance with an embodiment of the present disclosure;

FIG. 1B shows a second portion of an exemplary flow diagram for facilitating charitable donations, in accordance with an embodiment of the present disclosure;

FIG. 1C shows a third portion of an exemplary flow diagram for facilitating charitable donations, in accordance with an embodiment of the present disclosure;

FIG. 2 is a block diagram illustrating an exemplary computing system for facilitating charitable donations in accordance with an embodiment of the present disclosure;

FIG. 3 is a block diagram illustrating an exemplary system for facilitating charitable donations in accordance with an embodiment of the present disclosure;

FIG. 4 is a block diagram illustrating a various component in the computing system, such as those shown in FIG. 2, in accordance with an embodiment of the present disclosure;

FIG. 5 is a process flowchart illustrating an exemplary method for facilitating charitable donations, in accordance with an embodiment of the present disclosure;

FIG. 6 shows a block diagram of a first exemplary system for facilitating charitable donations, in accordance with an embodiment of the present disclosure;

FIG. 7A shows a flow chart of an exemplary method for facilitating charitable donations, in accordance with an embodiment of the present disclosure;

FIG. 7B shows a first portion of a flow chart of an exemplary second method for facilitating charitable donations, in accordance with an embodiment of the present disclosure;

FIG. 7C shows a second portion of a flow chart of an exemplary second method for facilitating charitable donations, in accordance with an embodiment of the present disclosure;

FIG. 7D shows a third portion of a flow chart of an exemplary second method for facilitating charitable donations, in accordance with an embodiment of the present disclosure;

FIG. 7E shows a first portion of a flow chart of an exemplary third method for facilitating charitable donations, in accordance with an embodiment of the present disclosure;

FIG. 7F shows a second portion of a flow chart of an exemplary third method for facilitating charitable donations, in accordance with an embodiment of the present disclosure;

FIG. 7G shows a third portion of a flow chart of an exemplary third method for facilitating charitable donations, in accordance with an embodiment of the present disclosure;

FIG. 8A shows a block diagram of an exemplary bank funding phase, in accordance with an embodiment of the present disclosure;

FIG. 8B shows a block diagram of an exemplary bank funding report phase, in accordance with an embodiment of the present disclosure;

FIG. 9 shows a block diagram of a second exemplary system for facilitating charitable donations, in accordance with an embodiment of the present disclosure;

FIG. 10A shows a block diagram of an exemplary system for loan origination, in accordance with an embodiment of the present disclosure;

FIG. 10B exemplary flow diagram of a Peach event stream, in accordance with an embodiment of the present disclosure;

FIG. 10C exemplary flow diagram of a Kafka event, in accordance with an embodiment of the present disclosure;

FIG. 10D exemplary flow diagram of a file generation function, in accordance with an embodiment of the present disclosure;

FIG. 11 shows an architecture of a third exemplary system for facilitating charitable donations, in accordance with an embodiment of the present disclosure;

FIG. 12 shows a block diagram of an exemplary system for funding and reporting donations, in accordance with an embodiment of the present disclosure;

FIG. 13A shows an exemplary graphical user interface (GUI) of a page to start a donation, in accordance with an embodiment of the present disclosure;

FIG. 13B shows an exemplary GUI of a first page to select a donation amount, in accordance with an embodiment of the present disclosure;

FIG. 13C shows an exemplary GUI of a second page to select a donation amount, in accordance with an embodiment of the present disclosure;

FIG. 13D shows an exemplary GUI of a third page to select a donation payment plan, in accordance with an embodiment of the present disclosure;

FIG. 13E shows an exemplary GUI of a page to enter memorial information, in accordance with an embodiment of the present disclosure;

FIG. 13F shows an exemplary GUI of a page to receive a donor's information, in accordance with an embodiment of the present disclosure;

FIG. 13G shows an exemplary GUI of a page to confirm the donor's information, in accordance with an embodiment of the present disclosure;

FIG. 13H shows an exemplary GUI of a page notifying the donor that a verification code has been sent, in accordance with an embodiment of the present disclosure;

FIG. 13I shows an exemplary GUI of a page to receive the verification code, in accordance with an embodiment of the present disclosure;

FIG. 13J shows an exemplary GUI of a first page to receive a donor's sensitive information, in accordance with an embodiment of the present disclosure;

FIG. 13K shows an exemplary GUI of a second page to receive a donor's sensitive information, in accordance with an embodiment of the present disclosure;

FIG. 13L shows an exemplary GUI of a page to confirm a donor's sensitive information, in accordance with an embodiment of the present disclosure;

FIG. 13M shows an exemplary GUI of a page to provide the donor a loan plan, in accordance with an embodiment of the present disclosure;

FIG. 13N shows an exemplary GUI of a page to receive a donor's payment information, in accordance with an embodiment of the present disclosure;

FIG. 13O shows an exemplary GUI of a page to receive a donor's bank information, in accordance with an embodiment of the present disclosure;

FIG. 13P shows an exemplary GUI of a page to select a donor's bank, in accordance with an embodiment of the present disclosure;

FIG. 13Q shows an exemplary GUI of a page to receive a donor's username and password for a selected bank, in accordance with an embodiment of the present disclosure;

FIG. 13R shows an exemplary GUI of a page to provide a confirmation that the donor's bank information was received, in accordance with an embodiment of the present disclosure;

FIG. 13S shows an exemplary GUI of a page to provide a confirmation to the donor that the loan has been approved, in accordance with an embodiment of the present disclosure;

FIG. 13T shows an exemplary GUI of a page wherein the donor opts to cover the program fee in addition to their donation, in accordance with an embodiment of the present disclosure;

FIG. 13U shows an exemplary GUI of a page to receive a confirmation that the donor accepts the terms and conditions, in accordance with an embodiment of the present disclosure;

FIG. 13V shows an exemplary GUI of a page to provide the donor with a notification that the donation has been submitted, in accordance with an embodiment of the present disclosure;

FIG. 14 shows a non-limiting example of a computing device; in this case, a device with one or more processors, memory, storage, and a network interface, in accordance with an embodiment of the present disclosure;

FIG. 15 shows a non-limiting example of a web/mobile application provision system; in this case, a system providing browser-based and/or native mobile user interfaces, in accordance with an embodiment of the present disclosure; and

FIG. 16 shows a non-limiting example of a cloud-based web/mobile application provision system; in this case, a system comprising an elastically load balanced, auto-scaling web server and application server resources as well synchronously replicated databases, in accordance with an embodiment of the present disclosure.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### DETAILED DESCRIPTION

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

Described herein, in certain embodiments, are computer-implemented systems for donating to a charitable non-profit organization (NPO), the system comprising: a digital processing device comprising: at least one processor, an operating system configured to perform executable instructions, a memory, and a computer program including instructions executable by the digital processing device to create an application comprising: an NPO registration module receiving a plurality of details of the NPO; a donation integration module creating a donation page accessible by the NPO to receive a donation; a donor registration module receiving an application for a loan to donate to the NPO; and a loan tracking module, providing a loan notification to the donor.

Also described herein, in certain embodiments, are computer-implemented methods of comprising: receiving, from a donor, a donor information and a donation amount to a non-profit organization (NPO); performing, by an integrated decision engine, a fraud and credit risk assessment, wherein: if the fraud and credit risk assessment is declined: transmitting a notification to the donor of the fraud and credit risk assessment decline; directing the donor to an NPO donation form; and appending the fraud and credit risk assessment decline to the donor information; and if the fraud and credit risk assessment is approved: transmitting a notification to the donor of the fraud and credit risk assessment approval; transmitting, to the donor receiving the fraud and credit risk assessment approval, a loan plan; generating an approved loan based upon the loan plan upon receipt of the donor's approval of the loan plan; and transmitting the donor information and the approved loan, to a system of record.

### Systems and Platforms for Facilitating Charitable Donations

In accordance with one embodiment of the disclosure, is a system for facilitating charitable donations. In some embodiments, the system provides essential funds to non-profit organizations (NPOs) for helping the poor, needy, hungry, and disadvantaged, worldwide. In some embodiments, the system comprises a memory coupled to a processor. In some embodiments, the memory comprises a set of program instructions in the form of a plurality of modules, and is configured to be executed by the processor.

In some embodiments, the plurality of modules comprises an NPO registration module. In some embodiments, the NPO registration module is configured to register one or more organization via a plurality of organization details for implementing a donation feature. In some embodiments, the plurality of organization details comprises an organization name, an organization working domain, organization slogans, organization donation details, or any combination thereof.

In some embodiments, the plurality of modules further comprises a donation integration module. In some embodiments, the donation integration module is configured to create a donation page of each of one or more registered organizations for a donor to donate money towards. Further, the created donation page is integrated with the system for donor access. In some embodiments, the created donation page comprises the organization name, organization working domain, organization slogans, organization donation details, and the like.

In such an embodiment, the donor may donate any chosen amount by just clicking the donate button. In some embodiments, the donation page may be customized in accordance with specific organizational needs. In some embodiments, the donor may access the created donation page via any user smart device.

In some embodiments, the system facilitates integration of loan facilities for donations. In some embodiments, the plurality of modules further comprises a donor registration module. In some embodiments, the donor registration module enables the donor accessing the donation page for access to a loan to donate for the chosen NPOs. In some embodiments, the loan stated is a no-cost point-of-donation loan.

Furthermore, the plurality of modules via a loan tracking module, enables the donor to track the loan payment, whereby on loan approval, the third-party loan provider organization directly transfers the loan to the chosen NPOs. In some embodiments, the loan tracking module then triggers a generation of tax donation receipts for the full amount of the loan and also charges the donor with a negotiable loan fee.

In such an embodiment, first the donor has to agree to the loan conditions provided by the third-party loan provider organization. On agreeing to a loan, the lender creates a loan account for the donor and then transfers the full amount of the donation in the donor's name to the NPOs by electronic means.

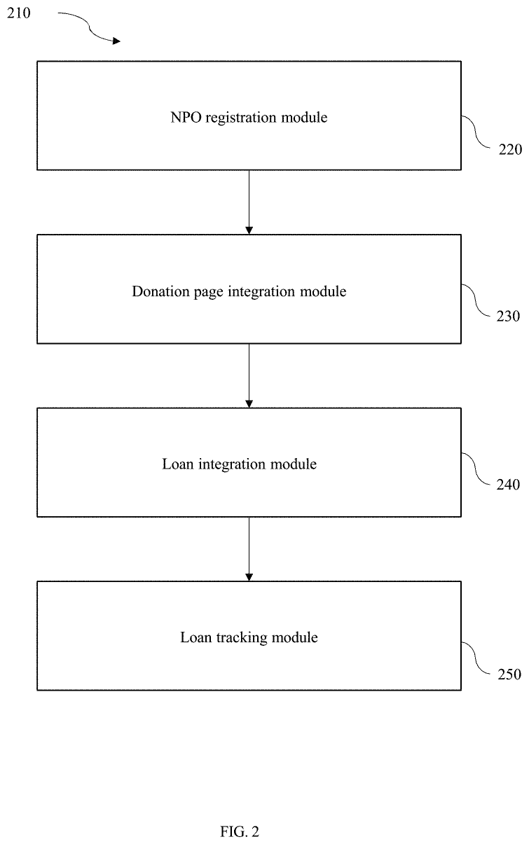

FIG. 2 is a block diagram illustrating an exemplary computing system 210 for facilitating charitable donations in accordance with an embodiment of the present disclosure. In some embodiments, the system 210 provides essential funds to NPOs for helping the poor, needy, hungry, and disadvantaged worldwide. In some embodiments, the increased fund is critical to time-sensitive emergencies needing aid.

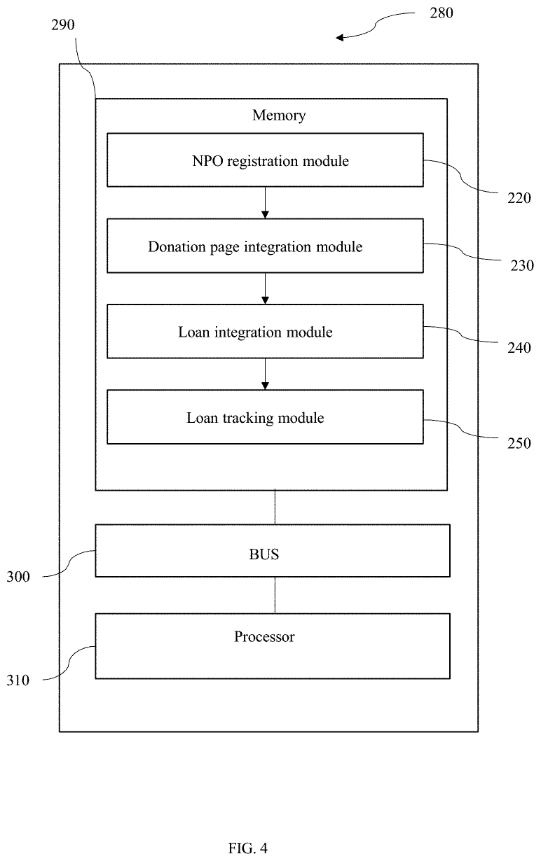

In some embodiments, the system 210 comprises a hardware processor 310. In some embodiments, the system 210 further comprises a memory 290 coupled to the processor 310. In some embodiments, the memory 290 comprises a set of program instructions in the form of a plurality of modules and configured to be executed by the processor 310 (as shown in FIG. 4).

In some embodiments, the plurality of modules comprises an NPO registration module 220. In some embodiments, the NPO registration module 220 is configured to register one or more organization via a plurality of organization details for implementing a donation feature. In some embodiments, the plurality of organization details comprise a donation address, a donation site ID, a donation site name, a maximum fund amount, a total yearly funded amount, or any combination thereof. In some embodiments, the plurality of organization details comprises organization name, organization working domain, organization slogans, organization donation details, and the like. Basically, any NPO provides their details first via the registration module 220 to access the system 210 features. In some embodiments, the registration provides data safety and any donor with proper information about any ongoing donation.

In some embodiments, the plurality of modules further comprises a donation integration module 30. In some embodiments, the donation integration module 230 is configured to create a donation page of each of one or more registered organization for a donor to pay. Further, the created donation page is integrated with the system for the donor access. In some embodiments, the created donation page comprises the organization name, organization working domain, organization slogans, organization donation details, and the like. It is pertinent to note that system 210 for providing a platform for any donor to donate to one or more organization, creates an organization donation page from where the donor may access the NPO's details. In some embodiments, the donor described here indicates any person donating for any NPO.

In such an embodiment, the donor may donate any chosen amount by just clicking the donate button. In some embodiments, the donation page may be customized in accordance with specific organization needs. In some embodiments, the user may access the created donation page via any user smart device.

Furthermore, the donor may also be interested in donating a more significant amount for any particular cause. For that, the system 210 facilitates integration of loan facilities for donations. In some embodiments, the plurality of modules further comprises a donor registration module 240. In some embodiments, the donor registration module 240 enables the donor accessing the donation page to apply for a loan to donate for the chosen NPOs. In some embodiments, the loan stated is a no cost point of donation loan. It is pertinent to note if the user utilizes the loan facility, the system 210 via the donor registration module 240 first registers the specific loan applying donor and routes such donor to third party financial lending sites giving such type of loan. In one embodiment, the system 210 may also help the donor decide which loan facility would be better suited in accordance with the financial condition of the donor.

Furthermore, the plurality of modules via a loan tracking module 250, enables the donor to track the loan payment, whereby on loan approval the third-party loan provider organization directly transfer the loan to the chosen NPO. In some embodiments, the loan tracking module 250 then triggers a generation of tax donation receipt for the full amount of loan and charges the donor with negotiable loan fee.

In such an embodiment, first the donor has to agree to the loan conditions provided by the third-party loan provider organization. On agreeing to a loan, the lender creates a loan account for the donor and then transfers the full amount of the donation in the donor's name to the NPO by electronic means. NPO agrees to absorb all fees and interest on the donation.

To comply with all financial regulations the system 210 does not hold or directly transfer any of these loan fund but monitors and tracks all the transfers so all parties may see what was donated, by whom, and when fees and interest were paid.

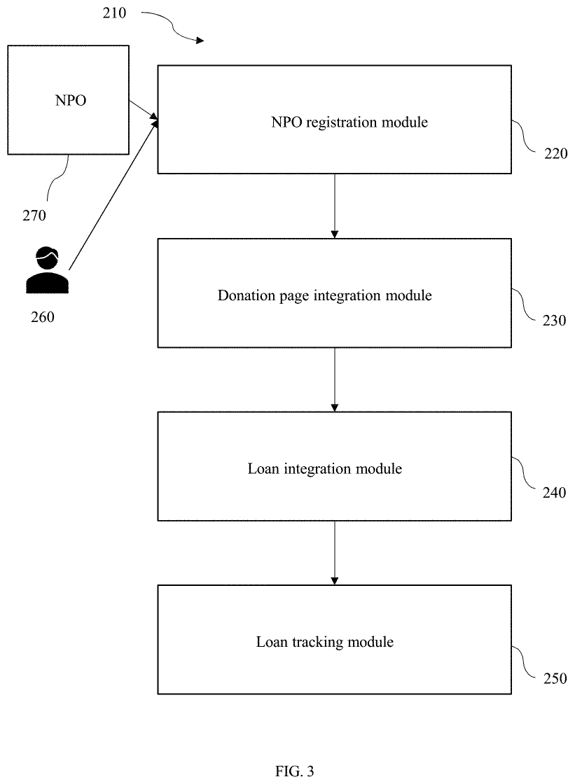

FIG. 3 is a block diagram illustrating an exemplary system 210 for facilitating charitable donations in accordance with an embodiment of the present disclosure. In some embodiments, the exemplary system 210 shows how a donor X 260 uses the system 210 to donate $500 to United Nations International Children's Emergency Fund (UNICEF) 270. In some embodiments, the system first registers via an organization registration module 220 the UNICEF 270 organization as a client. For registration it records every details of UNICEF 270. Details such as field of children working domain, the organization current working project and the like.

A donation page for UNICEF 270 current on-going project is created by the system 210 via a donation integration module 230. In some embodiments, the page is customized according to the need of the organization. In some embodiments, then the page is integrated with the system 210 for facilitating donation for individual doners. In some embodiments, the donor X 260 donates to any chosen amount by just clicking the donate button. In some embodiments, the donor X 260 donates $100 to the UNICEF 270 current on-going project.

A message might pop up saying “thank you for your generous donation which will feed a child for a month—please consider donating an extra $500 to feed a family”. To facilitate the system 210 may provide loan facilities. In some embodiments, the system 210 via a donor registration module 240, enables the donor X 260 to apply for a loan to donate. In some embodiments, the donor registration module 240 first registers the specific loan availing donor and routes such donor to third party financial lending sites giving such type of loans. In some embodiments, the third-party financial lending sites enable the donor X 260 to negotiate and loan the amount for donation.

In another exemplary embodiment, the donor X 260 may be given a provisional line of credit to use on a charity auction bidding site. This process is specific to charity biddings. If any client is about to bid on any item, the system 210 allows opportunity to apply for a loan upon proper negotiation. In some embodiments, the donor X 260 may bid up to that maximum and the successful winning bid will trigger the loan activation and subsequent routing of funds.

In yet another exemplary embodiment, the donor X 260 may agree for monthly donations. Here, rather than donating to a non-profit organization such as UNICEF 270 each month with an automatic subscription, the third-party lenders may pay the whole donation money at one instant. While the donor X 260 pays the lender each month.

Furthermore, the system 210 via a loan tracking module 250, enables the donor to track the loan payment. In some embodiments, the loan tracking module 250 then triggers a generation of tax donation receipt for the full amount of loan and charges the donor with negotiable loan fee.

In some embodiments, the NPO registration module 220, the donation integration module 30, a donor registration module 240 and a loan tracking module 250 in FIG. 3 is substantially equivalent to the NPO registration module 20, the donation integration module 30, the donor registration module 240 and the loan tracking module 250 of FIG. 2.

FIG. 4 is a block diagram illustrating a various component in the computing system, such as those shown in FIG. 2, in accordance with an embodiment of the present disclosure.

In some embodiments, the processor(s) 310, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

In some embodiments, the memory 290 comprises a plurality of modules stored in the form of executable program which instructs the processor 310 via bus 300 to perform the method steps illustrated in FIG. 2. In some embodiments, the memory 290 has following modules: the NPO registration module 220, the donation integration module 230, the donor registration module 40 and the loan tracking module 250.

In some embodiments, the NPO registration module 220 is configured to register one or more organization via a plurality of organization details for implementing a donation feature. In some embodiments, the donation integration module 230 is configured to create a donation page of each of one or more registered organization for a donor to pay. In some embodiments, the donor registration module 240 enables the donor accessing the donation page to apply for a loan to donate for the chosen NPOs.

In some embodiments, the donor registration module 240 first registers the specific loan applicant donor and routes such donor to third party financial lending sites giving such type of loan. In some embodiments, the loan tracking module 250 enables the donor to track the loan payment, whereby on loan approval the third-party loan provider organization directly transfer the loan to the chosen NPOs.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 310.

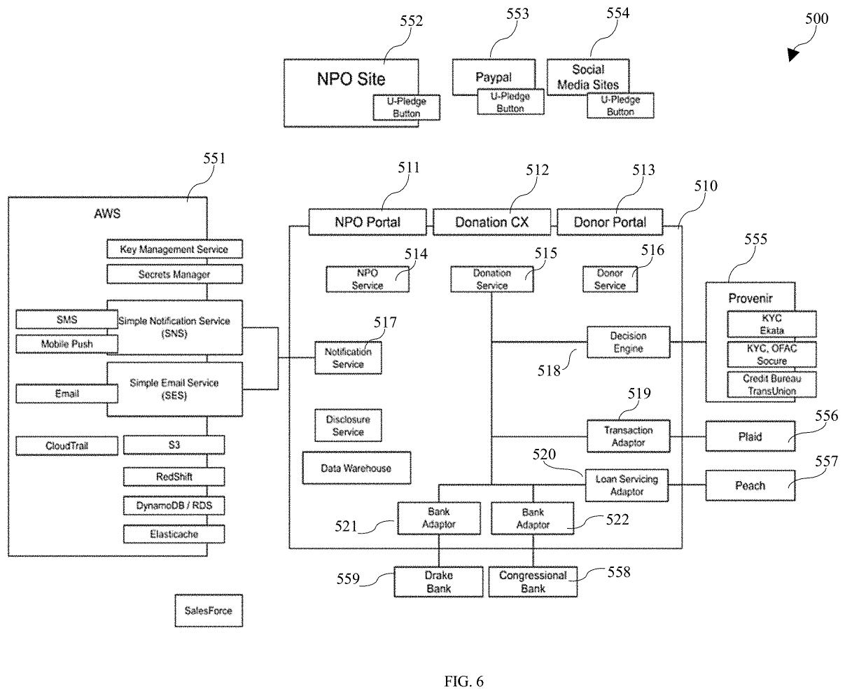

FIG. 6 shows a diagram of a first exemplary system 510 and platform 500 for facilitating charitable donations. In some embodiments, as shown the highly reliable, scalable, and secure platform 500 comprises the system for facilitating charitable donations 510 and a nexus of NPO sites, lenders, and 3rd party service providers. In some embodiments, the platform for facilitating charitable donations 500 further comprises NPO site buttons, application programming interfaces (APIs) for deeper integrations at the NPO, and supports additional entry points for donations through payments platforms.

In some embodiments, as shown, the system 510 comprises an NPO Portal 511, a Donation Customer Experience (CX) 512, and a Donor Portal 513. In some embodiments, the system 510 interfaces with Amazon Web Services (AWS) 551, an NPO Site 552 having a pledge button, PayPal 553 also having the pledge button, Social Media Sites 554 comprising the pledge button, Provenir 555, Plaid 556, Peach 557, a congressional bank 558, Drake Bank 559, Sales Force or any combination thereof.

In some embodiments, the system 510 comprises a donation service 515 in communication with a decision engine 518 that communicates with Provenir 555. In some embodiments, Provenir 555 is an artificial intelligence Decision Engine comprising an Ekata Know Your Customer (KYC), a KYC and Office of Foreign Assets Control (OFAC) source, and a credit Bureau TransUnion. In some embodiments, the donation service 515 is further in communication with a Transaction Adaptor 519, which communicates with Plaid 556. In some embodiments, the donation service 515 is further in communication with a first Bank Adaptor 521, which communicates with Drake Bank 559. In some embodiments, the donation service 515 is further in communication with a second Bank Adaptor 522, which communicates with the Congressional Bank 558. In some embodiments, the donation service 515 is further in communication with a Loan Servicing Adaptor 520, which communicates with Peach 557.

### Methods for Facilitating Charitable Donations

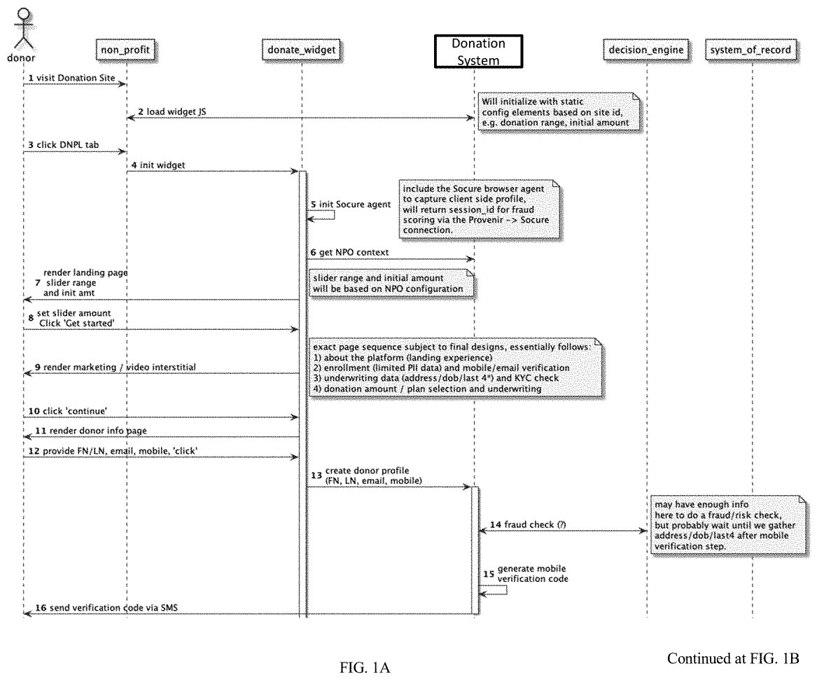

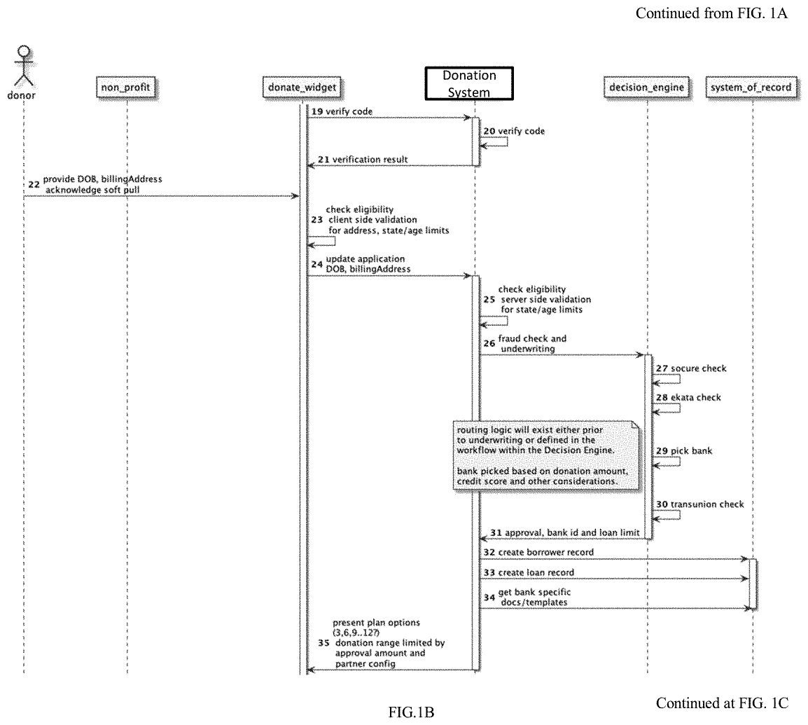

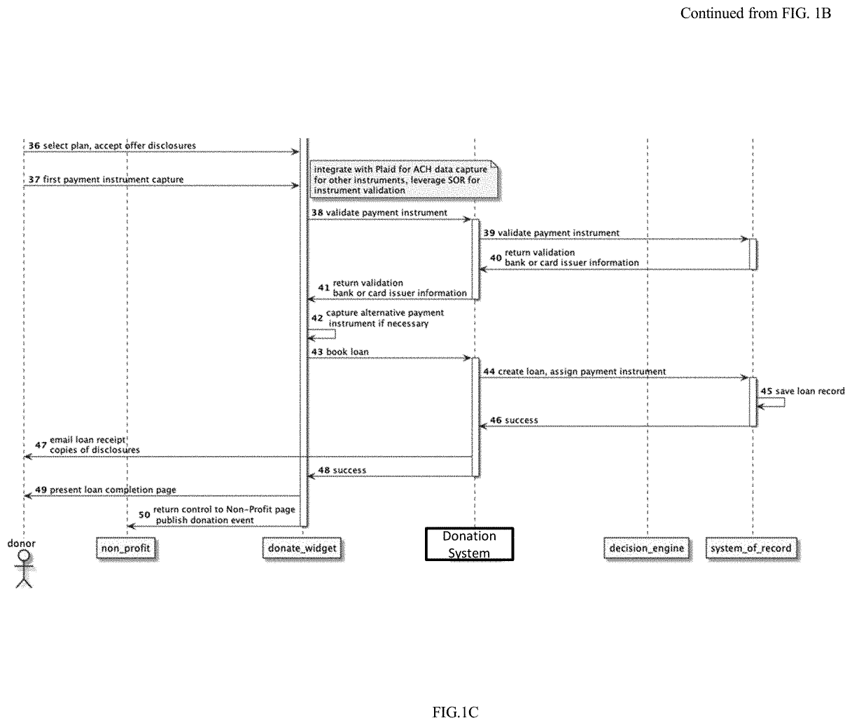

FIGS. 1A-1C show an exemplary flow diagram for facilitating charitable donations comprising the following method steps:
1) A donor visits a donation site
2) The donation system initializes with static configuration elements based on site id (e.g., donation range, initial amount) and loads widget JS at the NPO
3) The user clicks the DNPL tab
4) Init widget activates
5) The Socure browser agent of the donation widget captures client's side profile, will return session_id for fraud scoring via the Provenir→Socure connection
6) The donation widget gets the NPO context from the donation system
7) The donor's page renders a landing page with a donation range and initial amount based on NPO configurations
8) The donor sets the donation amount and clicks “Get Started”
9) The donation widget provides the donor with render marketing and a video interstitial comprising, for example: describing the platform, enrollment and mobile/email verification, underwriting data and KYC check, donation amount/plan selection and underwriting
10) The donor clicks continue
11) The donation widget renders a donor information page to the donor
12) The donor provides FN/LN, email, mobile, and clicks
13) The donation widget creates a donor profile
14) The donation system performs a fraud check with a decision engine, with or without collecting the donor's address, date of birth, social security number, or verification
15) The donation system then generates a mobile verification code
16) The donation system sends the donor the verification code via MS
17) The donation system also presents a validation request
18) The donor enters the validation code
19) The donation widget verifies the code
20) The donation system verifies the code
21) The donation system provides a verification result to the donation widget
22) The donor provides their date of birth, billing address, and acknowledge a soft pull
23) The donation widget checks eligibility and validation of address and state/age limits
24) The donation widget provides the donation system with the date of birth and billing address
25) The donation system checks eligibility and validation of address and state/age limits
26) The donation system transmits a request for fraud check and underwriting to the decision engine
27) The decision engine performs a Socure check
28) The decision engine performs a Ekata check
29) The decision engine selects a bank
30) The decision engine creates a TransUnion check
31) The decision engine transmits an approval, bank id, and loan limit to the donation system
32) The donation system creates a borrow record and transmits the borrow record to the system of record
33) The donation system creates a loan record and transmits the loan record to the system of
record
34) The donation system creates bank-specific documents and templates and transmits the
documents and templates to the system of record
35) The donation system transmits plan option donation ranges, limited by approval amount and
partner configuration, to the donation widget
36) The donor selects a plan and accepts offer disclosures
37) The donor provides instructions for a first payment capture, wherein the donation widget integrates with Plaid for ACH data capture for other instruments and leverages SOR for instrument validation
38) The donation widget transmits a payment instrument validation to the donation system
39) The donation system sends the payment instruction validation to the system of record
40) The system of record provides the donation system with a return validation with a bank or card issuer information
41) The donation system provides the donation widget with the return validation
42) The donation widget captures an alternative payment instrument if necessary
43) The donation widget books the loan via the donation system
44) The donation system creates a loan and assignment payment instructions to the system of record
45) The system of record saves the loan
46) The system of records provides a success notification to the donation system
47) The donation system provides the donor with email loan receipts and copies of the disclosures
48) The donation system transmits a notification of loan success to the donation widget
49) The donation widget provides the donor with a loan completion page
50) The donation widget returns control to the NOP page and publishes the donation event

In accordance with one embodiment of the disclosure, a method for facilitating charitable donations is disclosed. In some embodiments, the method comprises registering one or more organizations via a plurality of organization details for implementing a donation feature. In some embodiments, the method further comprises creating a donation page of each of the one or more registered organizations for a donor to pay. In some embodiments, the method further comprises integrating the created donation page with the system for donor access. In some embodiments, the method further comprises enabling the donor to apply for a loan in the created donation page to donate to the chosen NPOs. In some embodiments, the method further comprises tracking the loan payment for the donor.

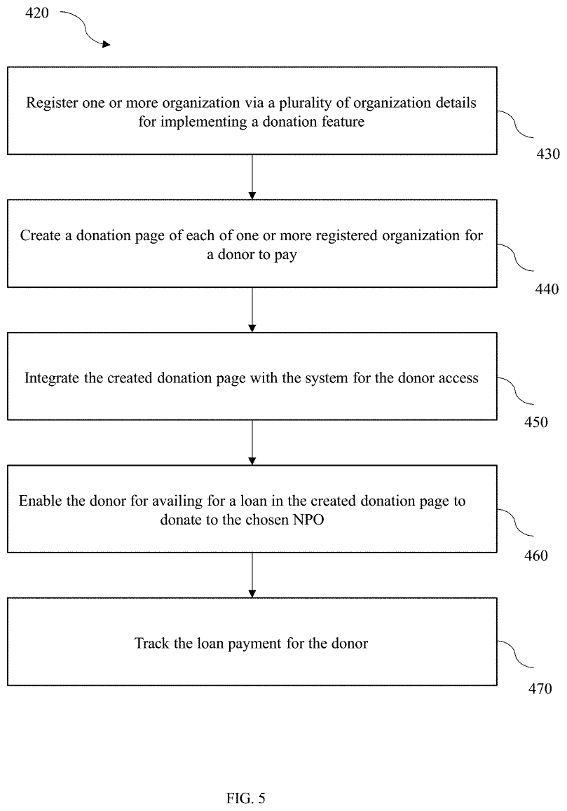

FIG. 5 is a process flowchart illustrating an exemplary method 420 for facilitating charitable donations in accordance with an embodiment of the present disclosure. At step 430, one or more organization is registered via a plurality of organization details for implementing a donation feature. In one aspect of a specific embodiment, the one or more organization is registered by an NPO registration module 220. In another aspect of the specific embodiment, the plurality of organization details comprises organization name, organization working domain, organization slogans, organization donation details, and the like.

At step 440, a donation page of each of one or more registered organization is created for a donor to pay. In one aspect of a specific embodiment, the donation page of each of one or more registered organization is created by a donation integration module 230. At step 450, the created donation page is integrated with the system for the donor access.

At step 460, the donor is enabled for availing for a loan in the created donation page to donate to the chosen NPOs. In one aspect of a specific embodiment, the donor is enabled for availing for a loan by a donor registration module 240. In such aspect of the specific embodiment, the method first registers the specific loan availing donor and routes such donor to third party financial lending sites for giving such type of required loan. Whereby on loan approval the third-party loan provider organization directly transfer the loan to the chosen NPOs.ds.

At step 470, the loan payment is tracked for the donor. In one aspect of a specific embodiment, the loan payment is tracked by loan tracking module 250. In such aspect of the specific embodiment, the system 210 triggers a generation of tax donation receipt for the full amount of loan. In some embodiments, the system charges the donor with negotiable loan fee. In some embodiments, the system does not charge the donor with negotiable loan fee.

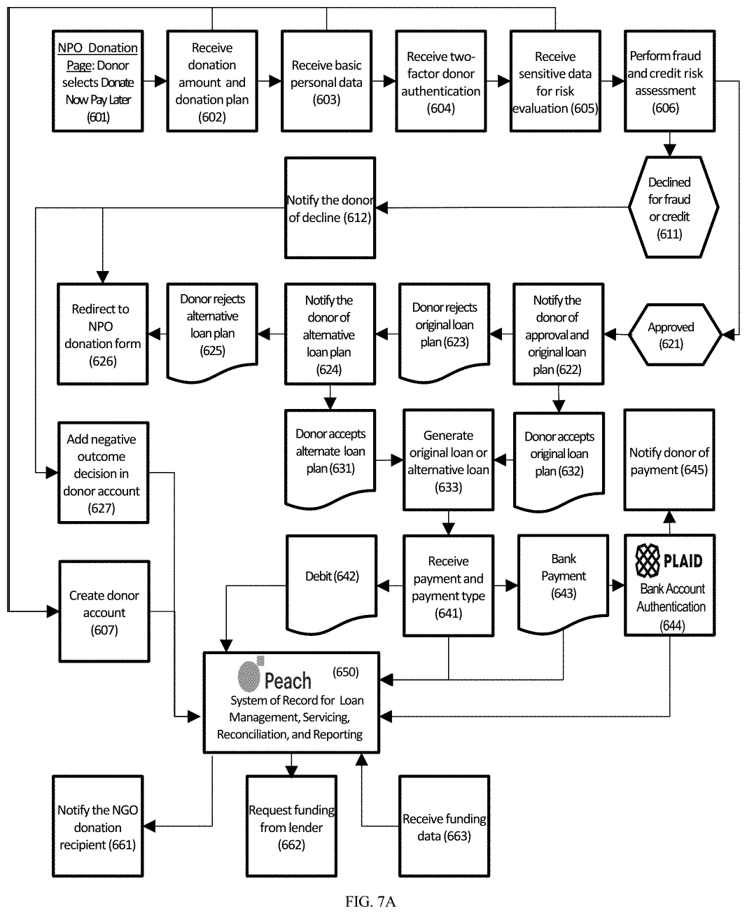

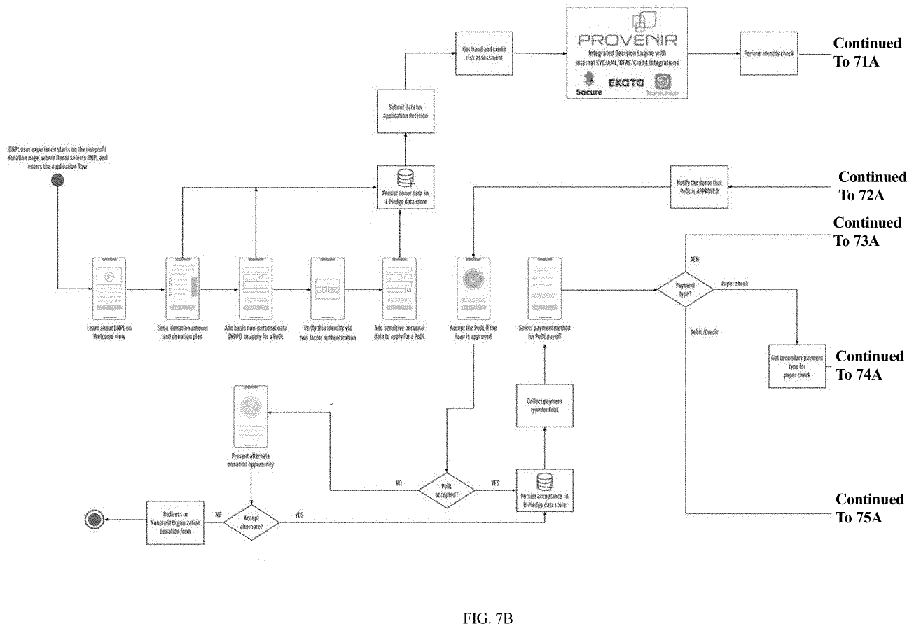

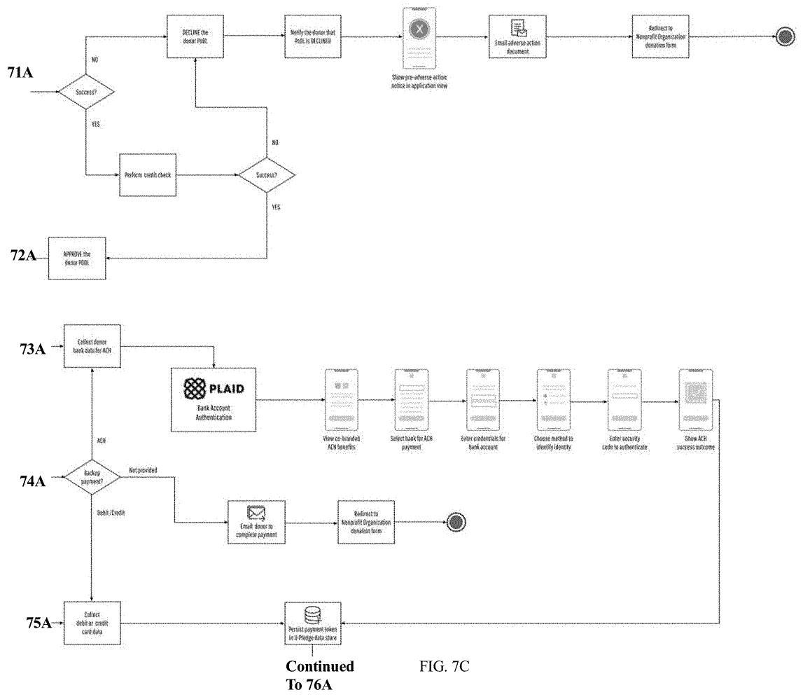

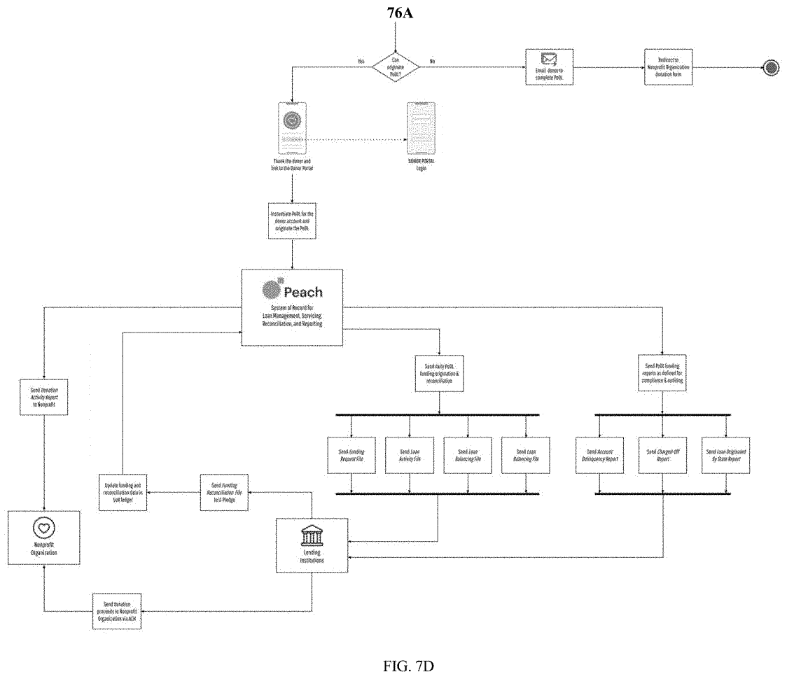

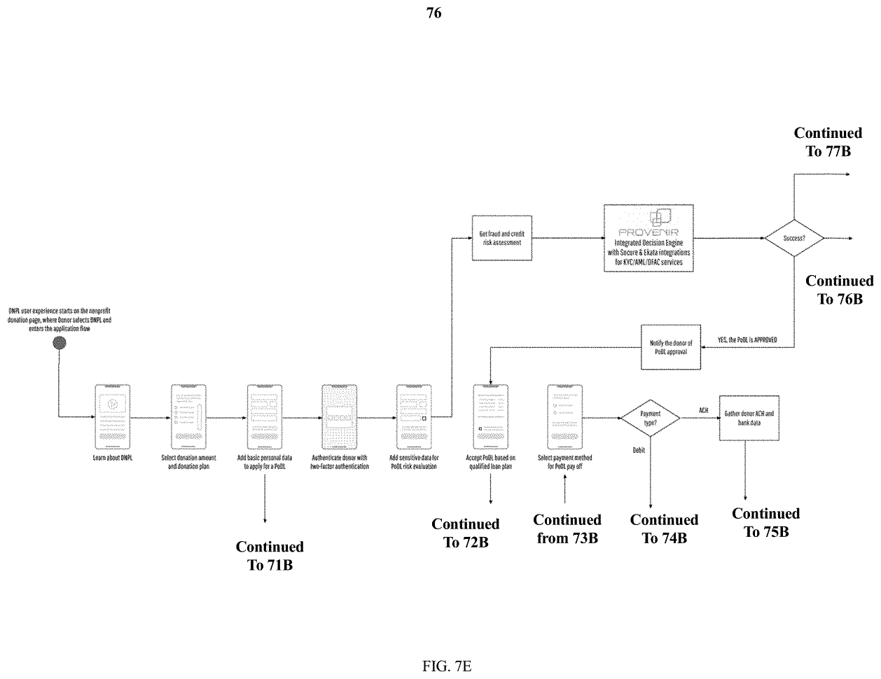

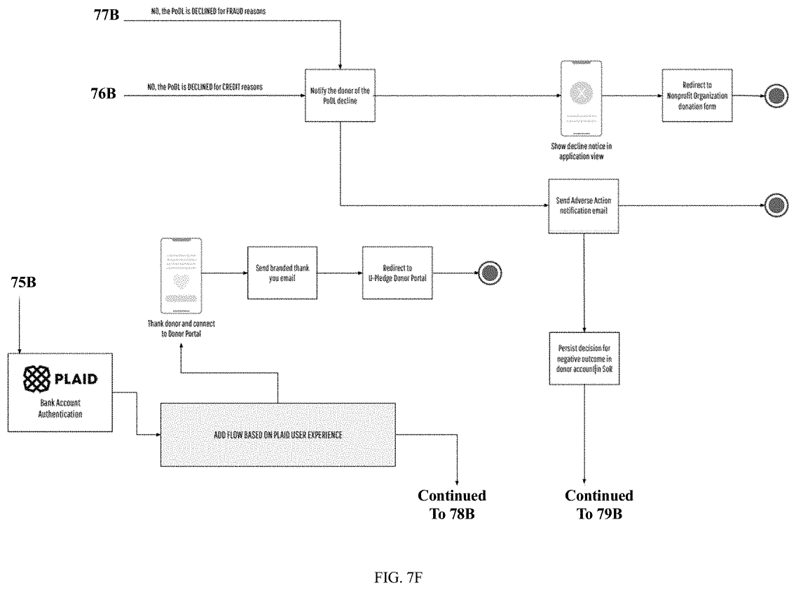

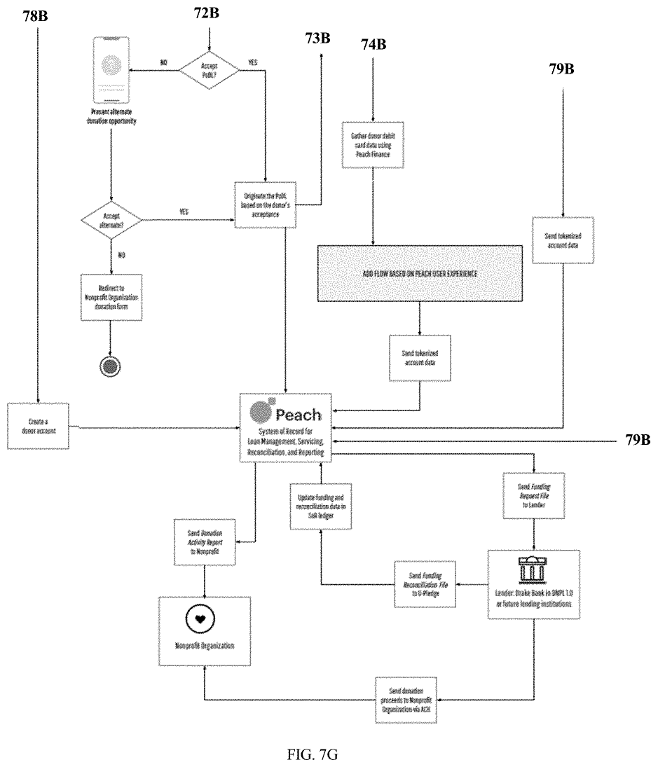

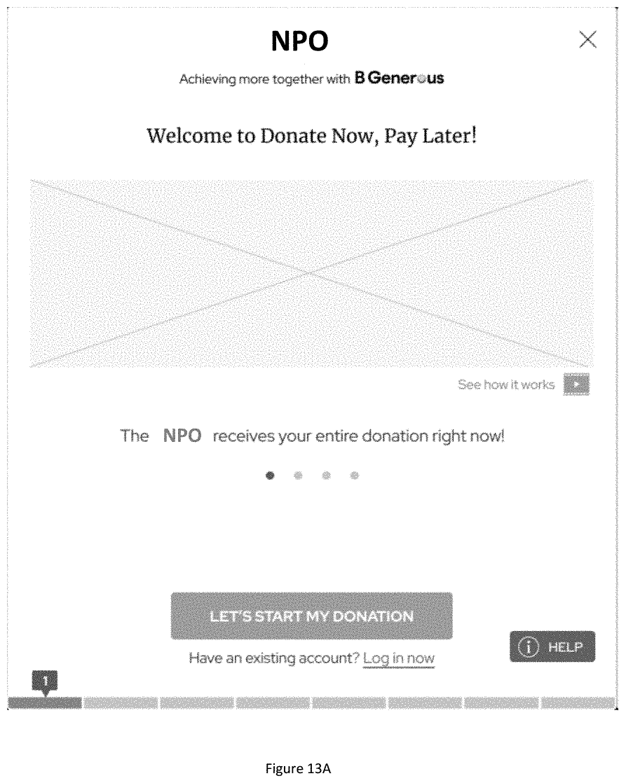

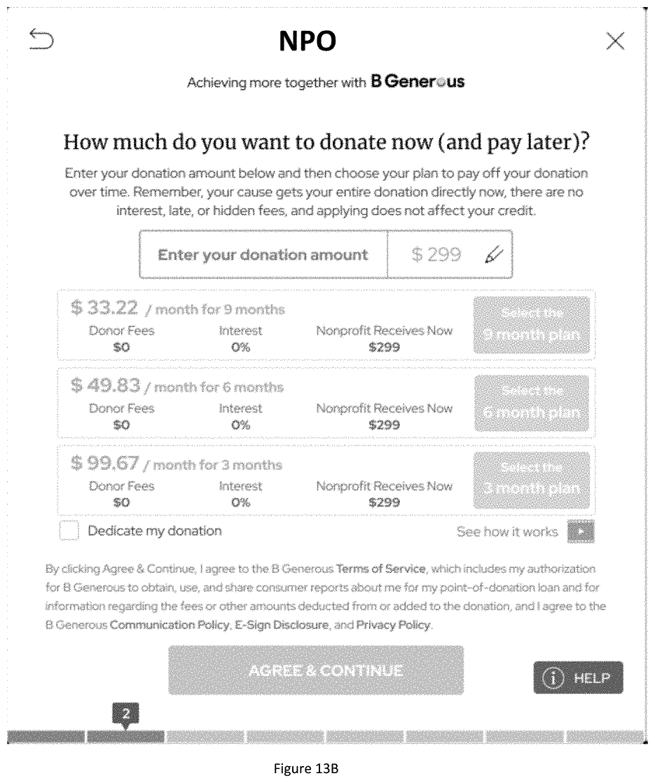

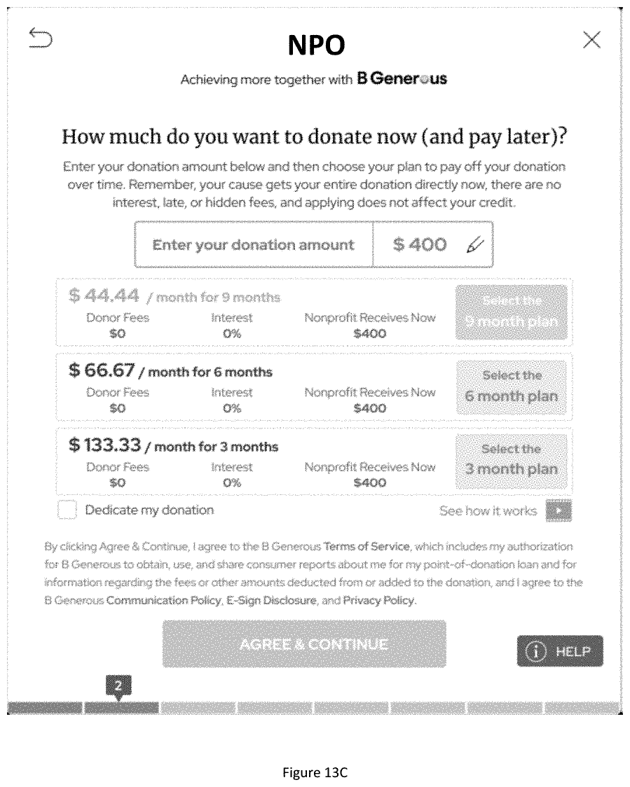

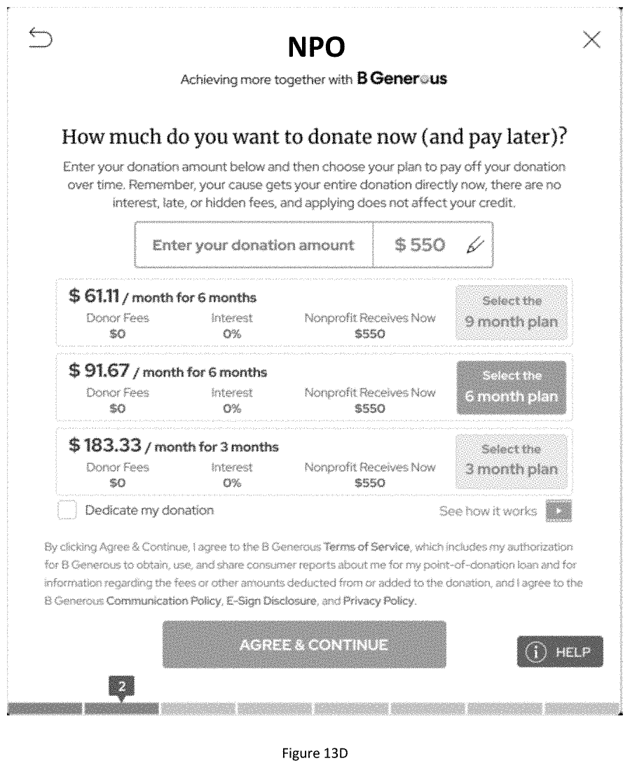

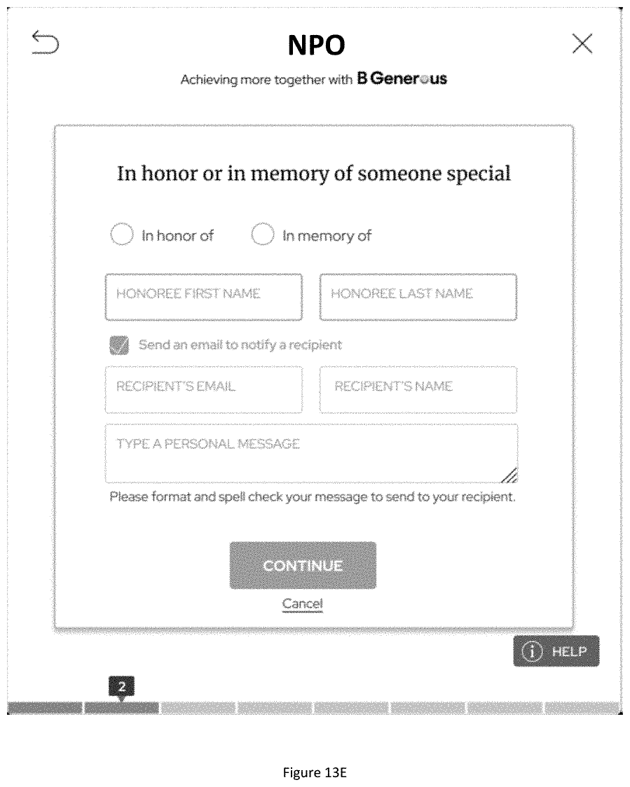

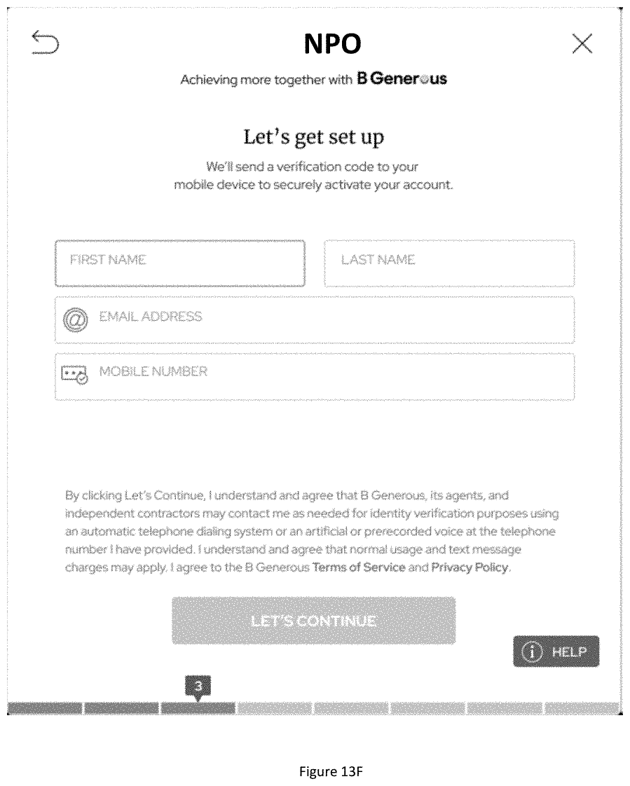

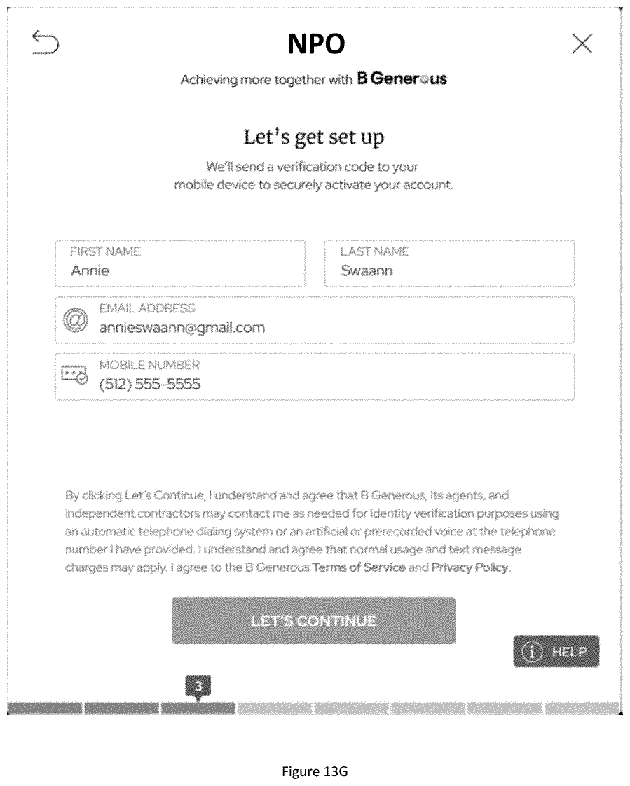

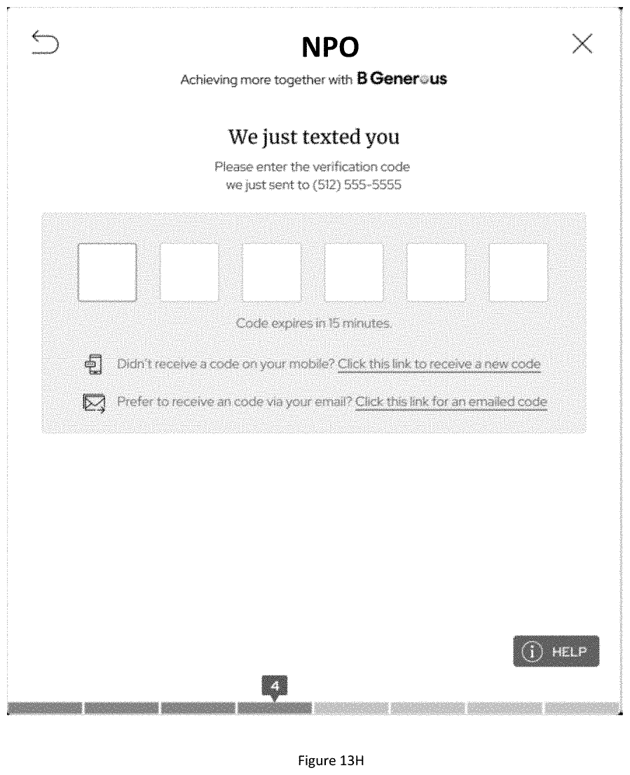

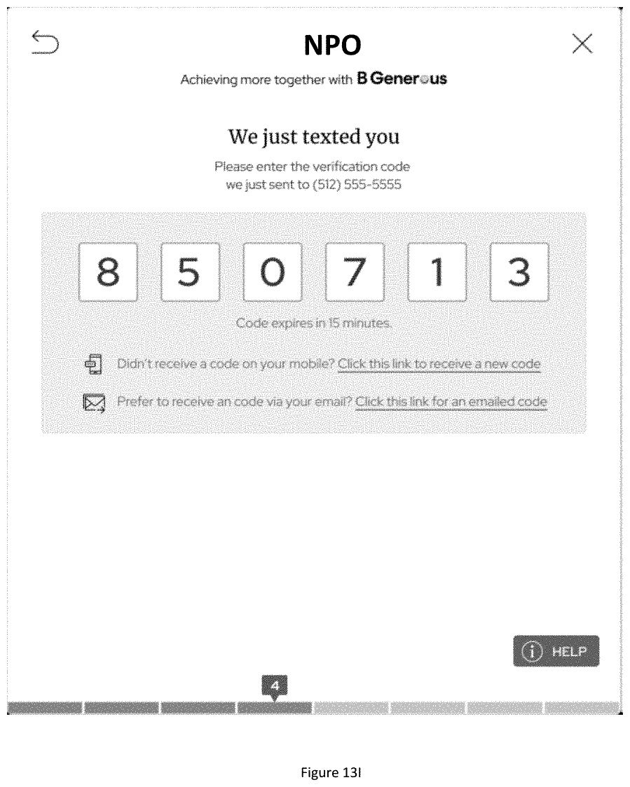

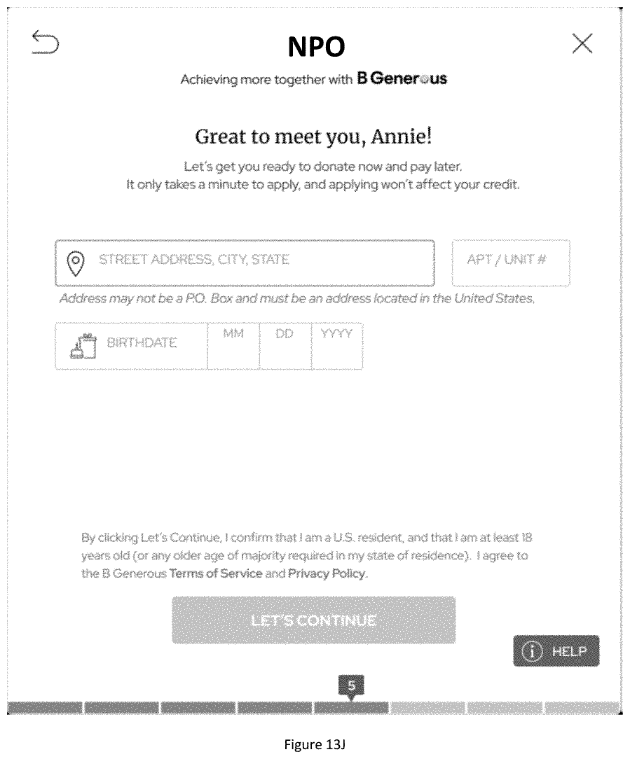

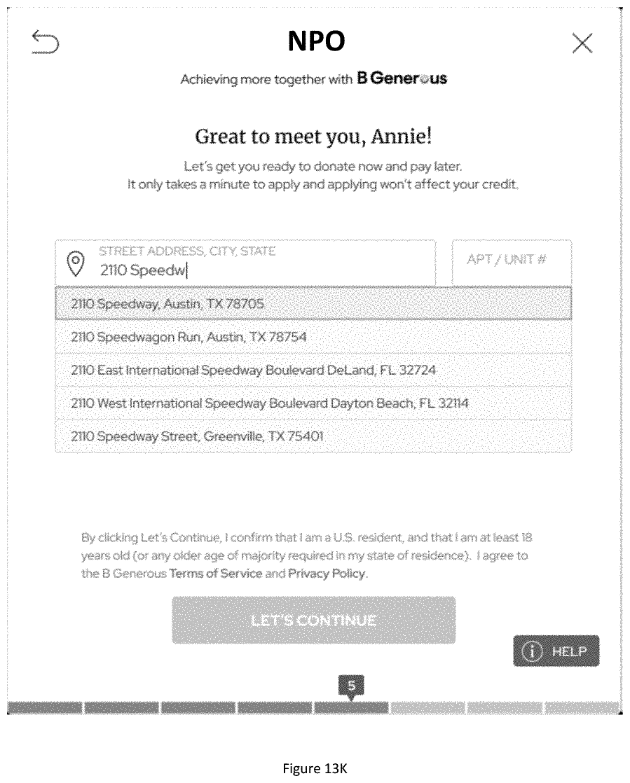

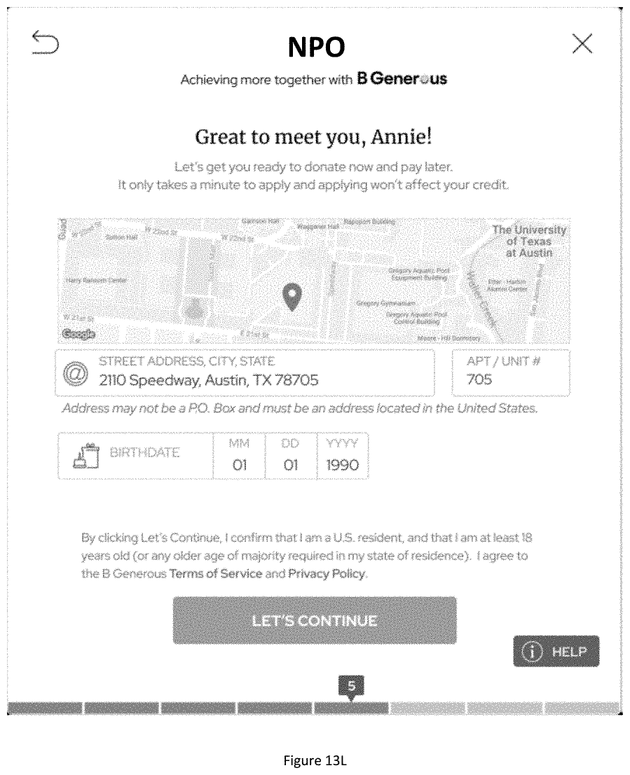

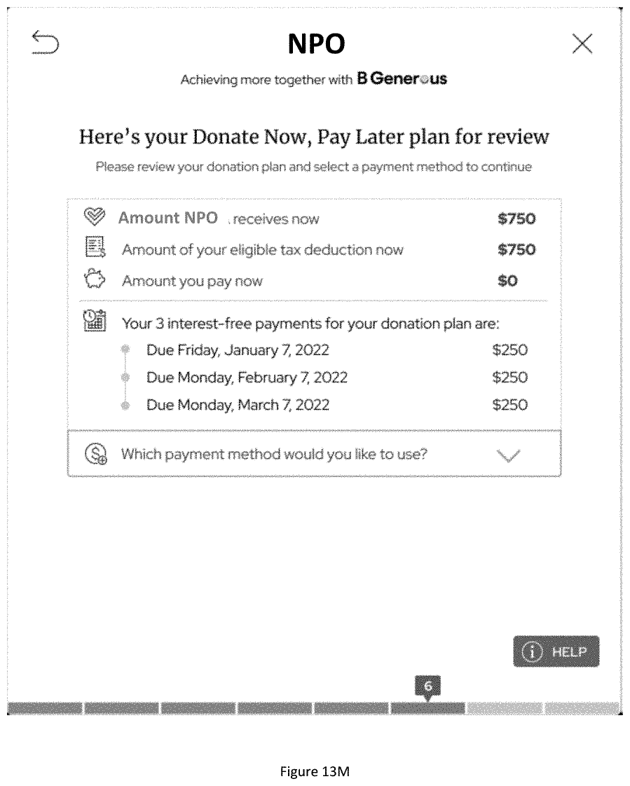

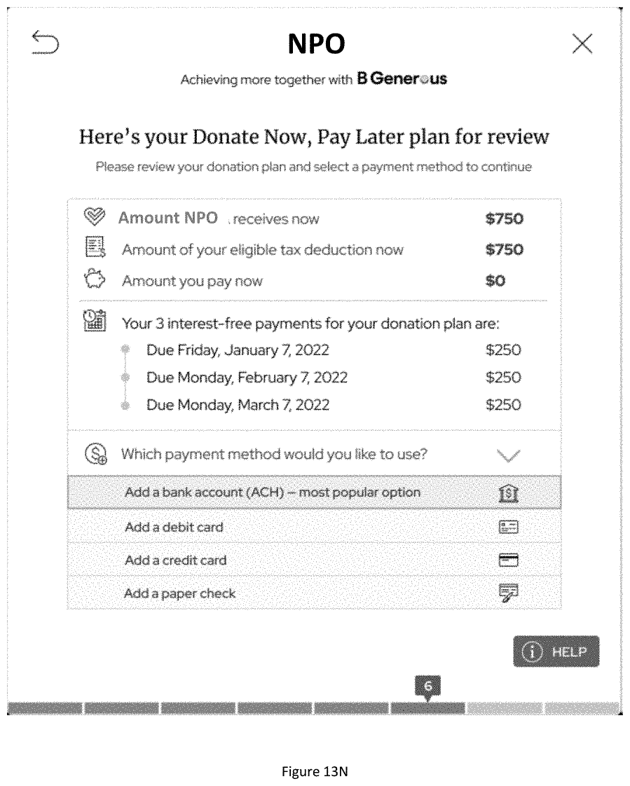

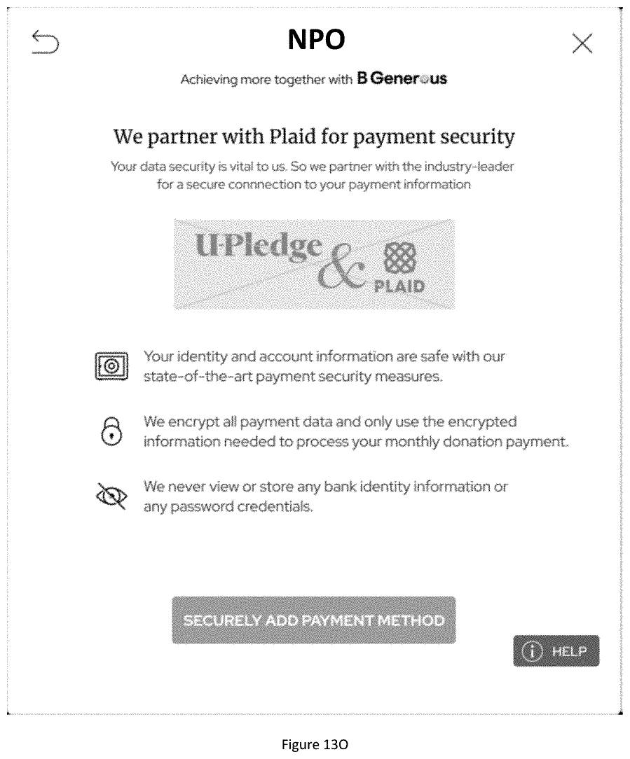

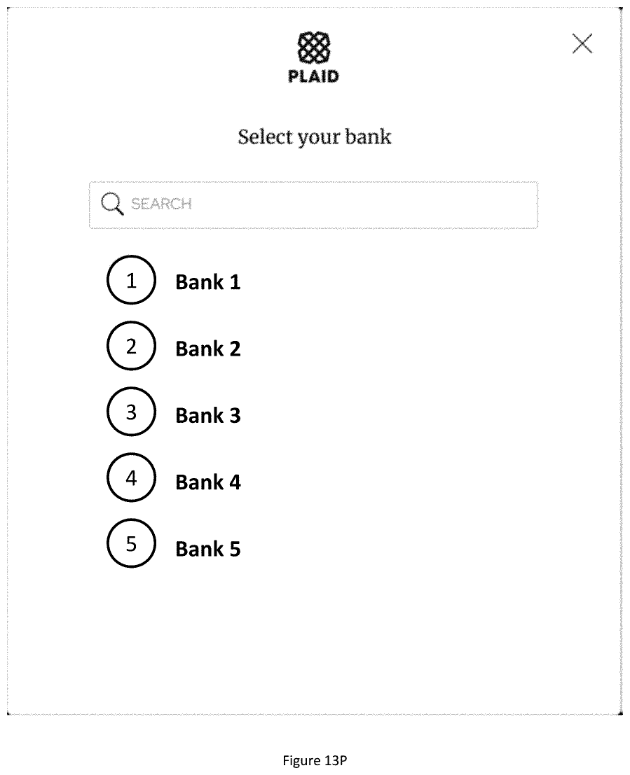

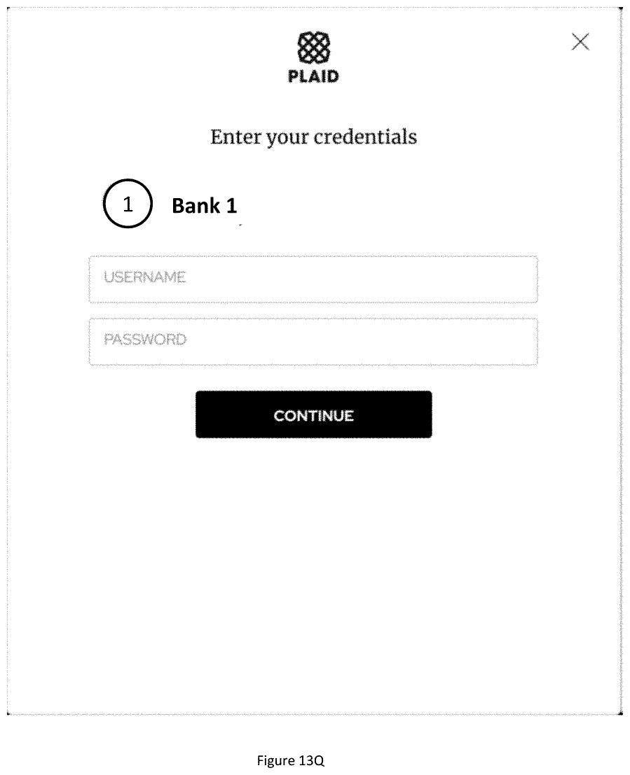

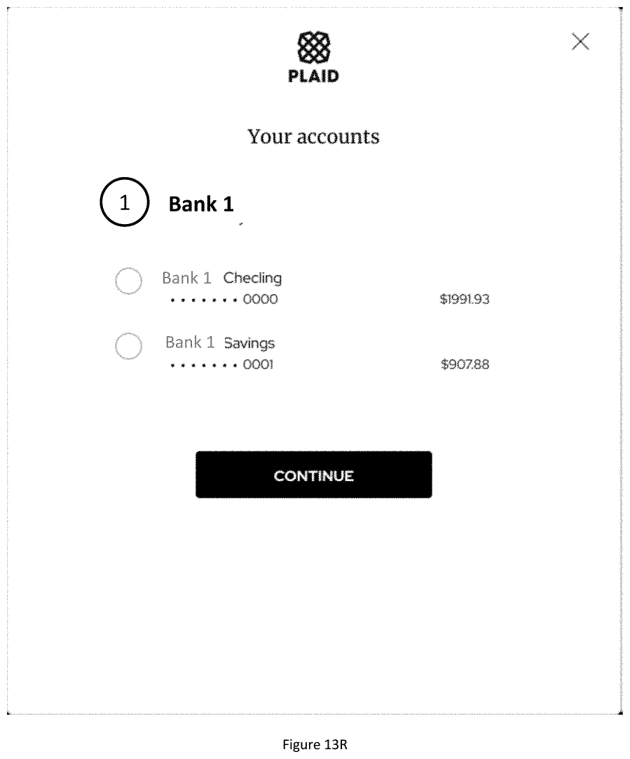

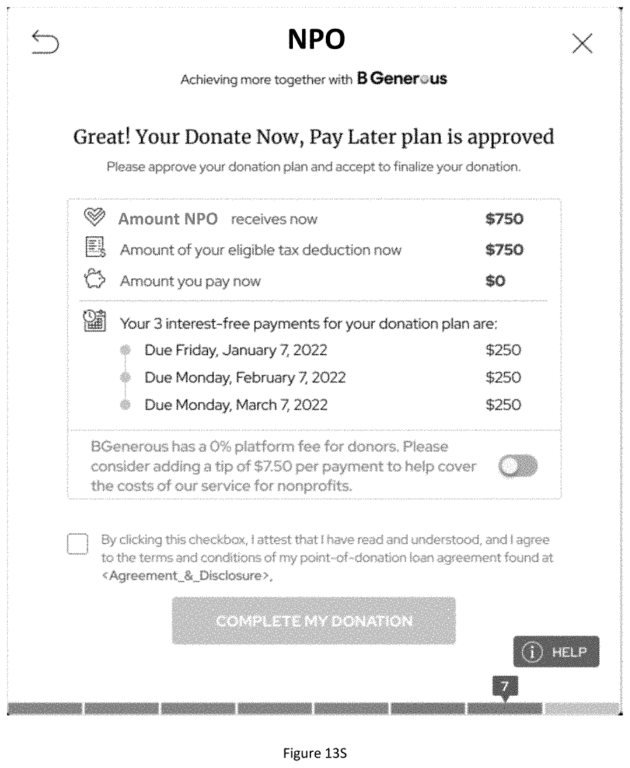

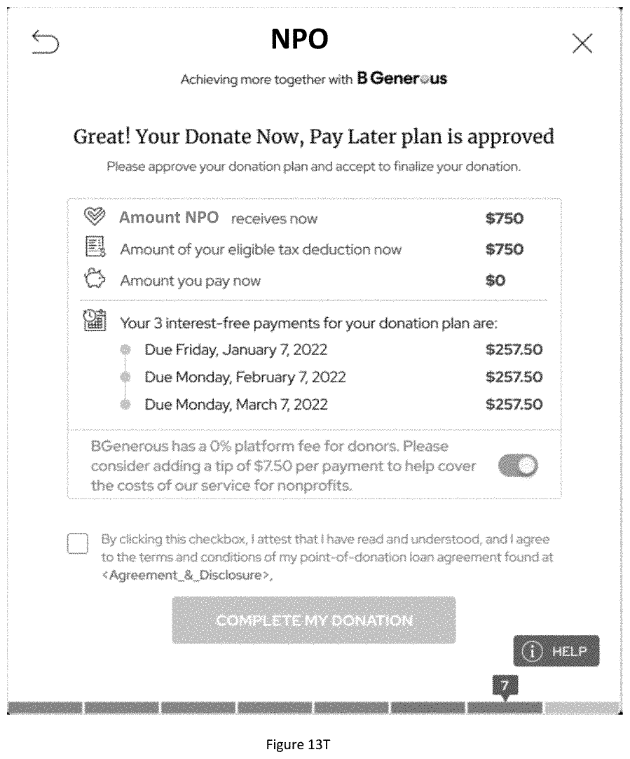

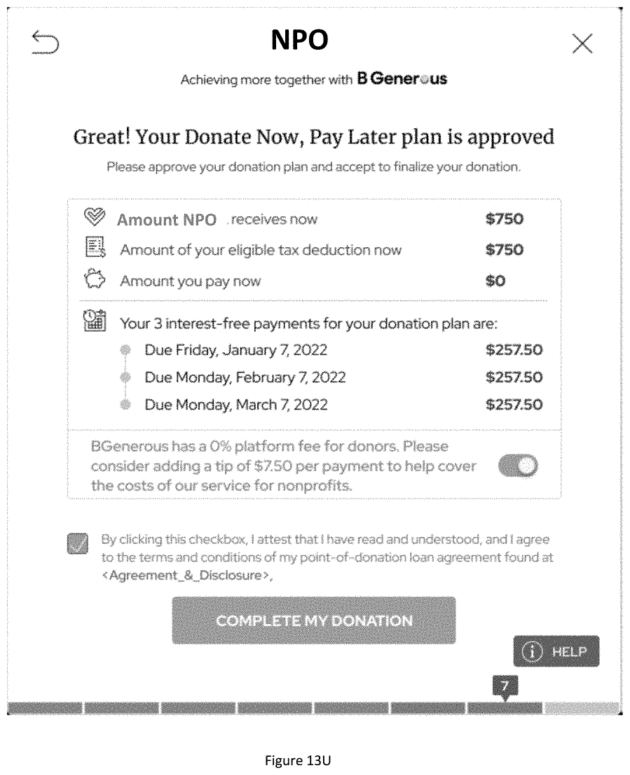

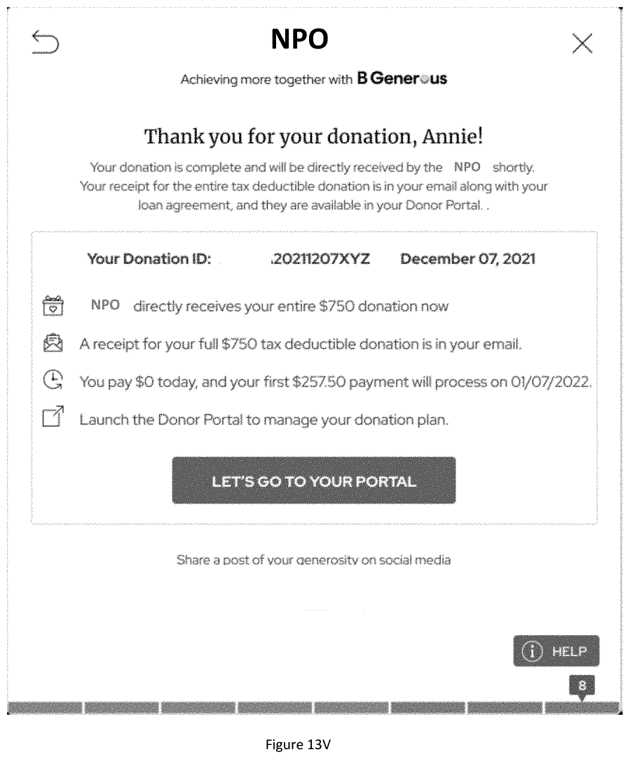

FIG. 7A shows a flow chart of an exemplary method for facilitating charitable donations. FIGS. 7B-7D shows a flow chart of an exemplary second method for facilitating charitable donations. FIGS. 7E-7G shows a flow chart of an exemplary third method for facilitating charitable donations. FIGS. 13A-13V show exemplary graphical user interfaces (GUIs) for a web application for facilitating charitable donations. As shown, in some embodiments, the method for facilitating charitable donations comprises a donor selecting a Donate Now Pay Later option on an NPO Donation Page 601, per FIG. 13A, receiving a donation amount and donation plan 602, per FIGS. 13B-13D, receiving basic personal data 603, per FIGS. 13F-13G, receiving a two-factor donor authentication 604, per FIGS. 13H-13I, receiving a sensitive data for risk evaluation 605 per FIGS. 13J-13L, and performing a fraud and credit risk assessment 606. In some embodiments, the basic personal data 603, the sensitive data for risk evaluation 605, or both comprise a donor's address, date of birth, email address, first name, citizenship, last name, middle initial, phone number, IP address, Socure token, or any combination thereof. In some embodiments, per FIG. 13E, the method further comprises receiving a memorial information for the donation.

In some embodiments, the fraud and credit risk assessment 606 is performed by an integrated decision engine (e.g., Provenir) In some embodiments, if the fraud and credit risk assessment is declined for fraud or credit 611, a notification is sent of the donor decline 612, the donor is redirected to an NPO donation form 626, the negative outcome decision is added to the donor's account 627 in Peach 650. In some embodiments, if the fraud and credit risk assessment is approved 621, a preview of a loan plan is sent to the donor 622, per FIGS. 13M-13N. If the donor rejects the original loan plan 623, a notification is sent of an alternative loan plan 624, wherein rejection of the alternative loan plan 625, redirects the donor to the NPO donation form 626. If the donor accepts the alternative loan plan 631 or the original loan plan 632, the alternative loan plan or the original loan plan is generated accordingly. In some embodiments, the system then receives a payment and payment type 641, wherein if the payment type is debit or credit 642, the payment is entered in Peach 650, and wherein if the payment type is a bank payment 643, the payment is sent to Plaid 644, per FIGS. 13O-R which notifies the donor of payment 645, per FIG. 13S, and transmits the payment information and the payment and payment type 641 to Peach 650. In some embodiments, once the bank payment 643 is sent to Plaid 644 the donor is presented with co-branded bank benefits, and provides their selected bank, bank credentials, and login/authentication parameters. In some embodiments, once the bank payment 643 is confirmed, the donor is notified and the received bank, bank credentials, and login/authentication parameters are saved in the U-Pledge system. In some embodiments, if the payment and payment type 641 is a check, a debit or credit 642 payment and/or a bank payment 643 is requested of the donor. In some embodiments, if the debit or credit 642 payment and/or the bank payment 643 is not received, the donor is notified and redirected to an NPO donation form 626.

Further, in some embodiments, the received basic personal data 603, the received sensitive data 605, the donation amount and plan, or any combination thereof is used to create a donor account 607 through Peach 650. Finally, in some embodiments, Peach 650 notifies the NPO donation recipient 661, request funding from the lender 662, and receives funding data 663. In some embodiments, one or more data sent to Peach 650 is tokenized. In some embodiments, one or more data received by Peach 650 is tokenized. In some embodiments, Peach 650 additionally sends a daily funding origination and/or reconciliation reports, comprising a funding request file, a loan activity file, a loan balancing file, or any combination thereof to the selected bank and/or loan institution. In some embodiments, Peach 650 further sends a compliance and auditing report, comprising an account delinquency report, a charged-off report, a loan originated by state report, or any combination thereof to the selected bank and/or loan institution.

In some embodiments, per FIGS. 13S-13U, the donor receives the option and provides their decision to cover or not to cover the program fee in addition to their donation, and/or to accept the terms and conditions of the loan. In some embodiments, per FIG. 13V, the donor provides a donation plan confirmation and is provided with a notification once the donation has been submitted. Further, in some embodiments, the donor is shown a welcome page to introduce them to the donate-now-pay-later system.

In some embodiments, the lender 662 is associated with a FICO distribution, an allocation percentage, a maximum band, a minimum band, a maximum allocation percentage, a lender identification, a lender name, a loaned amount, a maximum loaned amount, a TransUnion credit report, a requested loan amount, or any combination thereof. In some embodiments, the lender 662 is selected based on a FICO distribution, an allocation percentage, a maximum band, a minimum band, a maximum allocation percentage, a lender identification, a lender name, a loaned amount, a maximum loaned amount, a TransUnion credit report, a requested loan amount, or any combination thereof.

In some embodiments, the funding methods herein bridge between the donor's loan origination workflow and a bank's periodic ACH funding process for the NPO's deposit account. In some embodiments, the bank receives information about the NPO's bank account before the method commences. In some embodiments, the funding process is broken into 4 distinct phases: a loan origination phase; a bank funding request phase; a bank fund reporting phase; and consolidated fund reporting phase.

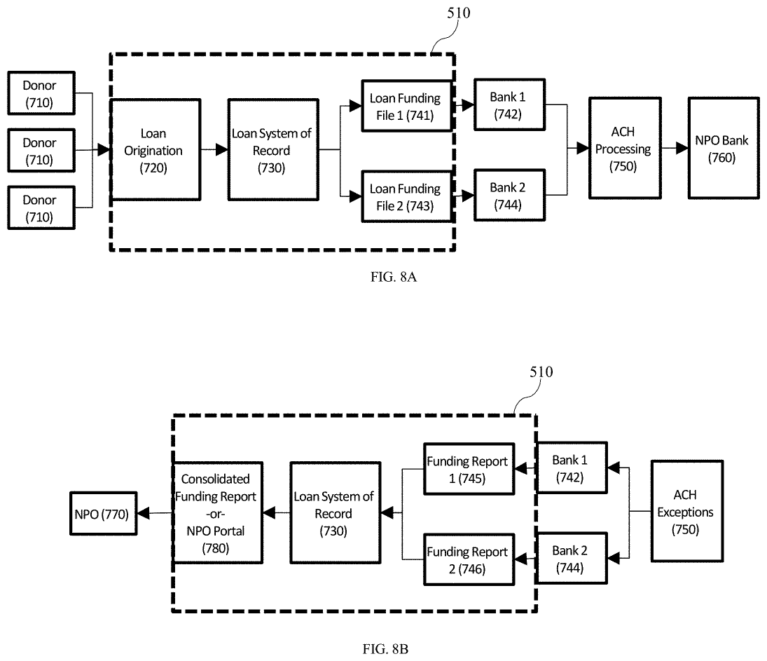

In some embodiments, in the loan origination phase, the platform processes loan originations, and persists the loans (e.g., through Peach) as they are requested from donors. FIG. 8A shows a block diagram of an exemplary method of a charitable donation funding phase. In some embodiments, as shown, the charitable donation funding phase begins when donors 710 request a loan. Thereafter, in some embodiments, a loan origination 720 and a loan system of record 730 are formed. In some embodiments, in the bank funding request phase the system 510 periodically (e.g., daily) creates first loan funding file 741, a second loan funding file 743, or both (e.g., loan tape) from the Peach System of Record. In some embodiments, the first loan funding file 741 is sent to a first bank 742, the second loan funding file 743 is sent to a second bank 744, or both. In some embodiments, the first bank 742, the second bank 744, or both trigger funding of the NPO's bank 760 through ACS processing 760. In some embodiments, the extract file is transmitted through an SFTP endpoint configured to securely receive the loan funding file, an API endpoint, or an API for individual records within the extract.

In some embodiments, in the bank funding report phase, the bank periodically sends the platform the settlement status of the funding requests, any fees that are held back, any chargebacks/reversals that may be needed to reconcile funding activities, or any combination thereof. In some embodiments, per FIG. 8B, the bank funding report phase begins with ACH exceptions 750 updating a status to the first bank 742 and the second bank 744, wherein the first bank 742 provides a first funding report 745 and the second bank 744 provides a second funding report 746, which are compiled by the loan system of record 730. In some embodiments, a consolidated funding report, an NPO portal, or both 780 are then formed and sent to the NPO 770.

In some embodiments, the platform further updates the funding status in the Peach system of record. In some embodiments, in the consolidated funding report phase, the platform creates a consolidated funding report that contains all the loan funding status updates, and sends the consolidated funding report to the fundraiser by a secure means (e.g., via SFTP).

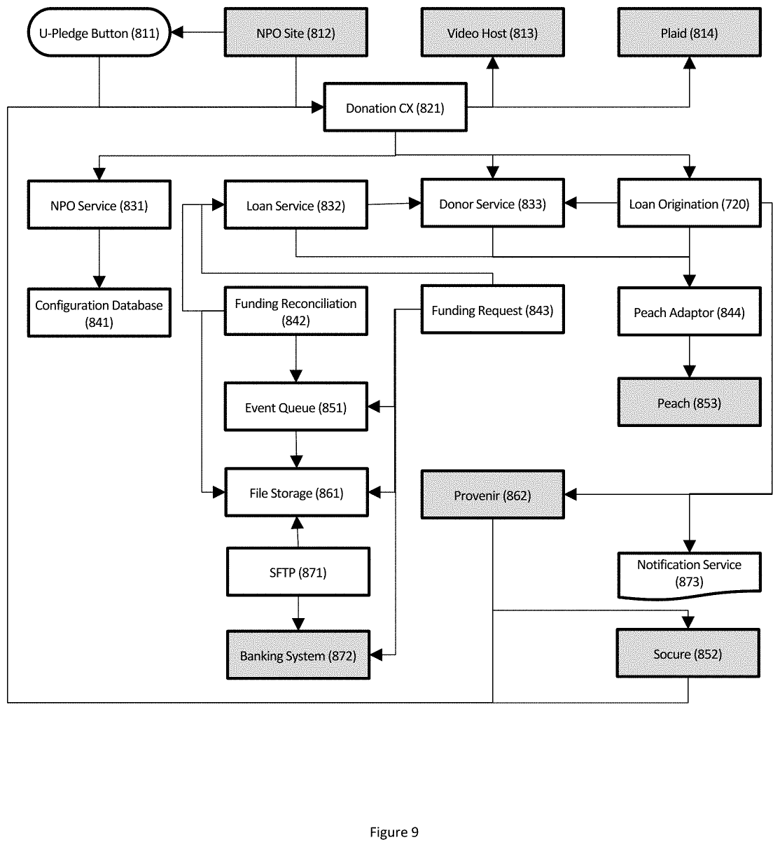

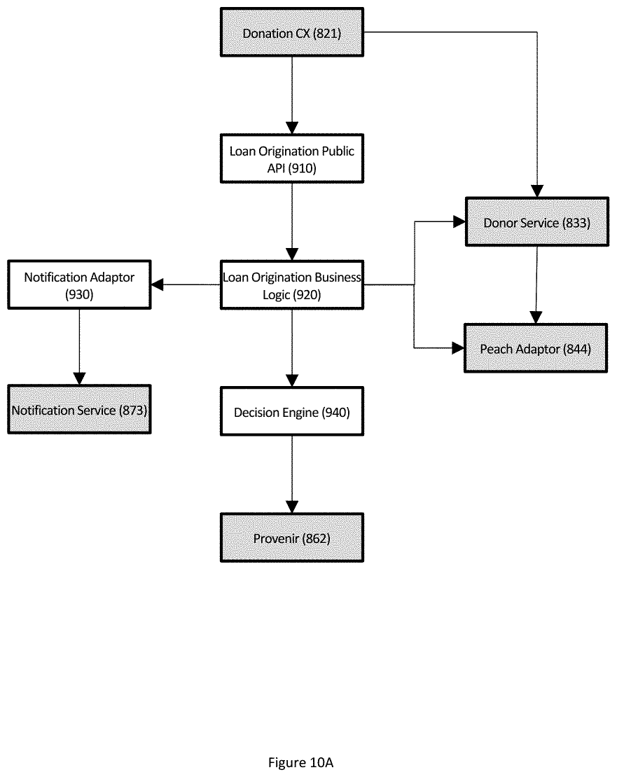

FIG. 9 shows a block diagram of a second exemplary system for facilitating charitable donations. In some embodiments, as shown, an NPO site 812 includes, via JavaScript, a U-Pledge button 811 that initiates a Donation CX Module 821. In some embodiments, the Donation CX Module 821 provides an embedded video to a Video Host 813, and embeds a Plaid software 814. In some embodiments, the Donation CX Module 821 further provides NPO information to an NPO service Module 831, which reads from and writes to a configuration database. In some embodiments, the Donation CX Module 821 also transmits donor information to a Donor Service Module 833, which allows returning donors to access their data. In some embodiments, the Donation CX Module 821 further sends a loan request to a Loan Origination Module 720. In some embodiments, the Donation CX Module 821 receives blackbox information from Socure 852. In some embodiments, the Donor Service Module 833 receives donor information from the Loan Origination Module 720 and from a Loan Service Module 832. In some embodiments, the Donor Service Module 833 reads and writes from a Peach Adaptor Module 844. In some embodiments, the Loan Origination Module 720 provides a loan information to the Peach Adaptor Module 844, calls a public API from Provenir 862, and sends a message to a Notification Service Module 873. In some embodiments, the Loan Service Module 832 receives a funding status from a Funding Reconciliation Module 842, receives information regarding a new loan from a Funding Request Module 843, and services the loan through the Peach Adaptor Module 844. In some embodiments, the Peach Adaptor Module 844 reads and writes from a Peach service 853. In some embodiments, the Funding Reconciliation Module 842 provides a notification to an Event Queue Module 851 that the loan file is ready to process, and provides loan files to a File Storage Module 861. In some embodiments, the File Storage Module 861 receives files from the Funding Request Module 843, receives uploads from a SSH File Transfer Protocol (SFTP) Module 871, and triggers events in the Event Queue Module 851. In some embodiments, a Banking System Module 872 provides files to the SFTP Module 871, and receives files from the Funding Request Module 843. In some embodiments, the NPO Site Module 812, the Video Host 813, Plaid 814, Peach 853, Provenir 862, Socure 852, and the Banking system 872, or any combination thereof exists outside the U-Pledge system.

In some embodiments, the lending platform herein generate and provide a National Automated Clearing House Association (NACHA) file and a Payment Activity Report File to banking partners. In some embodiments, Peach is an exemplary system of record. In some embodiments, Moov is an exemplary 3rd party, standalone service for generating NACHA files. In some embodiments, a NACHA File is a set of instructions that triggers a batch of ACH payments as soon as it is uploaded into a bank's portal. In some embodiments, the NACHA file comprises account numbers in clear text in an encrypted form. In some embodiments, the systems and methods herein trace what records were included into one or more of the files, and schedule periodic tasks for file generation and data extraction. In some embodiments, loggers and/or alerts are placed for the Peach Event Stream Consumer, the Kafka Topic Consumer, the File Generation Function, the Moov Service, or any combination thereof to log any failure during communication.

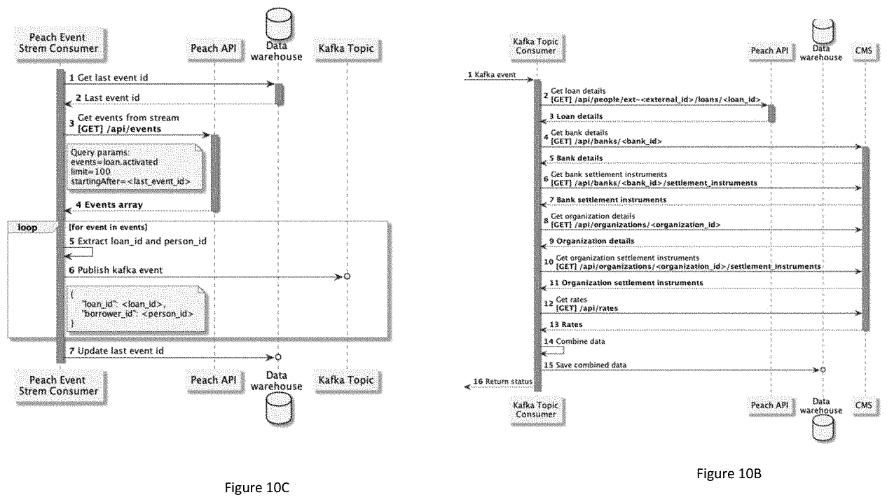

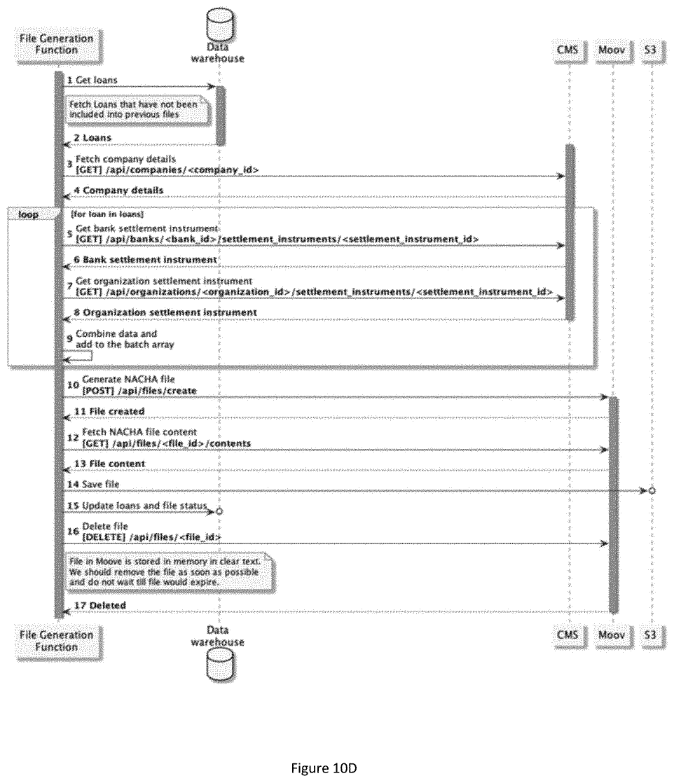

FIG. 10A shows a block diagram of an exemplary system for loan origination. In some embodiments, as shown, the Donation CX Module 821 sends a request to a Loan Origination Public API 910, and sends donor information to the Donor Service Module 833. In some embodiments, the Loan Origination Public API 910 uses a Loan Origination Business Logic Module 920, which sends a notification to the Notification Service Module 873, initiates the Decision Engine 940, provides donor information to the Donor Service Module, and transmits loan data to the Peach Adaptor 844. In some embodiments, the Donor Service Module 833 reads and writes in the Peach Adaptor Module 844. In some embodiments, Provenir 862 receives a public API call from the Decision Engine 940, and a Notification Service Module 873 receives a notification text from the Notification Adaptor Module 930. In some embodiments, the Loan Origination Public API 910, the Loan Origination Business Logic 920, the Notification Adapter Module 930, and the Decision Engine 940 for, a Loan Origination Service.

FIG. 10B exemplary flow diagram of a Peach event stream. In some embodiments, for each event type, we will have separate stream consumer. To extract data from Peach API an event stream is used through Peach's API. In some embodiments, for each event type, a Lambda function is created and periodically executed to fetch a given type of event from the Peach API events endpoint, and extract data for future processing in a corresponding Kafka Topic. In some embodiments, a Data Warehouse is updated with the last event identification. In some embodiments, as shown, the Peach event stream comprises:
1. A Peach Event Stream Consumer providing a last event identification to a data warehouse;
2. The data warehouse providing the last event indication to the Peach Event Stream Consumer;
3. The Peach Event Stream Consumer providing events from a stream to the Peach API;
4. The Peach API returning an events array;
5. For each event: The Peach Event Stream Consumer extracts a loan identification and a person identification;
6. For each event: The Peach Event Stream Consumer publishes a Kafka event to a Kafka Topic; and
7. The Peach Event Stream Consumer providing the data warehouse with an updated last event identification.

FIG. 10C exemplary flow diagram of a Kafka event. In some embodiments, a separate consumer is employed for each consumer. In some embodiments, after the Peach Event Stream Consumer extracts and uploads event data into a Kafka Topic, a Kafka Topic Consumer extracts needed data (e.g., loan or payment activity details) from the Peach API. In some embodiments, the Kafka Topic Consumer calls a Configuration Management Service (CMS) to fetch missing data (e.g., rates/fees, bank settlement instrument identifications). In some embodiments, all data is then combined into a Data Warehouse database to avoid storing account number in multiple places. In some embodiments, the Data Warehouse keeps the last 4 account numbers for a supportability and settlement instrument identification that allows a function to access the correct settlement instrument for a given record. In some embodiments, as shown, the Kafka Topic Consumer Event comprises:

1. A Kafka event initiation;

2. The Kafka Topic Consumer requesting loan details to the Peach API;

3. The Kafka Topic Consumer receiving loan details from the Peach API;

4. The Kafka Topic Consumer requesting bank details to the CMS;

5. The Kafka Topic Consumer receiving bank details from the CMS;

6. The Kafka Topic Consumer requesting bank settlement instructions to the CMS;

7. The Kafka Topic Consumer receiving bank settlement instructions from the CMS;

8. The Kafka Topic Consumer requesting organization details to the CMS;

9. The Kafka Topic Consumer receiving organization details from the CMS;

10. The Kafka Topic Consumer requesting organization settlement instructions to the CMS;

11. The Kafka Topic Consumer receiving organization settlement instructions from the CMS;

12. The Kafka Topic Consumer requesting rates to the CMS;

13. The Kafka Topic Consumer receiving rates from the CMS;

14. The Kafka Topic Consumer combining the data;

15. The Kafka Topic Consumer saving the combined data to the data warehouse; and

16. The Kafka Topic Consumer returning a status.

FIG. 10D exemplary flow diagram of a file generation function. In some embodiments, a separate File Generation Function is performed for each file. In some embodiments, the File Generation Function fetches records and generates a requested file from the records. In some embodiments, in a NACHA file function fetches a settlement instrument and combines the data therein into special object/array for each record that was not included in a previous file. In some embodiments, once filled, the object/array is sent to a Moov service to generate a NACHA file. In some embodiments, the content of the file from Moov is saved it to an S3 file bucket, and information about the file (e.g., file status) in copied to a Data Warehouse to update the associated loan record. In some embodiments, the Moov service files are deleted and then stored in memory in a non-encrypted form. In some embodiments, as shown, the File Generation Function performs:

1. Requesting a loan from the data warehouse;

2. Receiving a loan from the data warehouse;

3. Fetching company details from CMS;

4. Receiving company details from CMS;

5. For each loan: requesting a bank settlement instrument;

6. For each loan: receiving a bank settlement instrument;

7. For each loan: requesting an organization settlement instrument;

8. For each loan: receiving an organization settlement instrument;

9. For each loan: combining the data;

10. Providing a generated NACHA file to Moov;

11. Receiving a file from Moov;

12. Fetching a NACHA from Moov;

13. Receiving the NACHA file from Moov;

14. Saving the file to the S3 bucket;

15. Updating loans and file status in the data warehouse;

16. Requesting that the Moov files be deleted; and

17. Receiving a confirmation that the Moov files have been deleted.

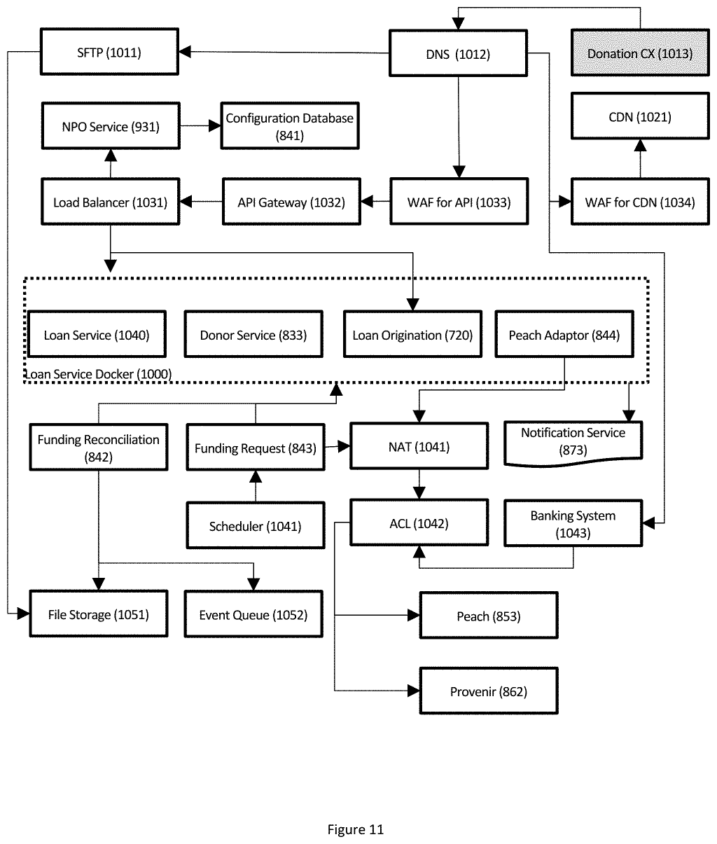

FIG. 11 shows an architecture of a third exemplary system for facilitating charitable donations. In some embodiments, as shown, a Donation CX Module 1013 transmits a request to a domain name system (DNS) 1012. In some embodiments, the DNS 1012 forwards the request to a Web Application Firewall (WAF) for API 1033 and to a WAF for content delivery network (CDN) 1034. In some embodiments, the DNS 1012 further receives files from a Banking System Module 1043, and redirects connections to an SFTP Module 1011. In some embodiments, the WAF for CDN 1034 forwards a request to a CDN 1021. In some embodiments, the WAF for API 1033 forwards a request to an API Gateway Module 1032, which forwards the request to a Load Balancer 1031. In some embodiments, the Load Balancer 1031 sends donor information to a Loan Service Docker 1000, sends requests to a Loan Origination Module 720, transmits donation limits and NPO information to an NPO Service Module 931, and transmits a trigger to a Notification Service Module 873. In some embodiments, the NPO Service Module 931 reads and writes from a Configuration Database 841. In some embodiments, the Loan Service Docker 1000 receives requests from a Funding Reconciliation Module 842 and a Funding Request Module 843. In some embodiments, the Loan Service Docker 1000 comprises a Loan Service Module 1040, a Donor Service Module 833, the Loan Origination Module 720, and a Peach Adaptor Module 844. In some embodiments, the Funding Reconciliation Module 842 reads files from the File Storage 1051 and transmits events to an Event Queue Module 1052. In some embodiments, the Funding Request Module 843 receives periodic triggers from a Scheduler 1041 and provides information to the Network Address Translation (NAT) 1041. In some embodiments, the NAT 1041 receives information from the Peach Adaptor Module 844 and transmits data to the Access Control List (ACL) 1042. In some embodiments, the ACL 1042 provides data to a Banking System Module 1043, which sends files to the DNS 1012. In some embodiments, the ACL 1042 further provides data to Peach 853 and Provenir 862.

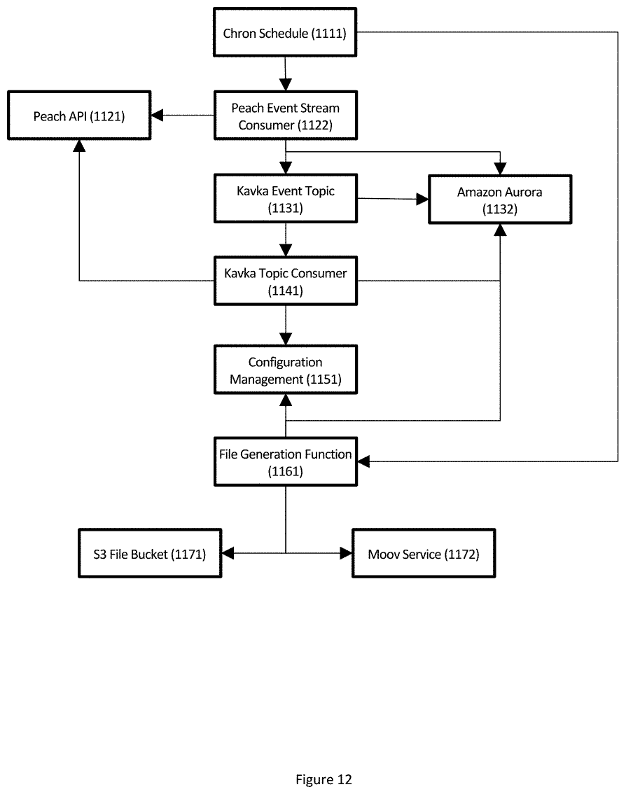

FIG. 12 shows a block diagram of an exemplary system for funding and reporting donations. In some embodiments, as shown, a Chron Schedule Module 1111 transmits data to a Peach Event Stream Consumer 1122, and to a File Generation Function Module 1161. In some embodiments, the Peach Event Stream Consumer 112 sends data to a Peach API 1121, a Kafka Event Topic Module 1131, and Amazon Aurora 1132. In some embodiments, the Kafka Event Topic Module 1131 transmits data to Amazon Aurora 1132 and to a Kafka Topic Consumer Module 1141. In some embodiments, the Kafka Topic Consumer Module 1141 transmits data to Amazon Aurora 1132, the Peach API 1121, and a Configuration Management Module 1151. In some embodiments, a File Generation Function Module 1161 transmits data to the Configuration Management Module 1151, a S3 File Bucket 1171, and a Moov Service 1172. In some embodiments, the File Generation Function Module 1161 receives data from the Chron Schedule Module 1111. Exemplary rules for loan financing are shown in Table 1 below:

TABLE 1
Requirements for new donors
Non-Profit max funding amount has not been exceeded
Lender max funding amount has not been exceeded
Over 18 or (other state requirements)
US address and SSN
Requirements for return donors
Registered (regardless of active status)
Not past due by more than 15 days
Passes maximum lending limits
Passes credit check
Requirements for all donors
No OFAC, Socure, or Ekata adverse actions
Return donor benefits
Same lender as last lender
Open credit launch
Percentage Allocation by lender
TRANSUNION Requirements
No bankruptcy
Not enrolled in debt settlement program
No accounts currently in collections
No tradelines past due 30+
No accounts in deferment/forbearance except for student loans
Maximum number of inquiries in L6M
Minimum number of tradelines
Minimum FICO rating
Revolving Credit Utilization <= 75%
Credit line requirements
Potential Credit Limit (PCL) is less than 120% of Total Monthly Loan Payments (TMLP)
Minimum Actual Credit Limit (ACL) based on Vantage/FICO score and PCL

| Vantage Score | Actual Credit Limit | Donation Cap |
|---|---|---|
| >800 | >$2,500 | $20,000 |
| 751-800 | >$2,000 | $10,000 |
| 726-750 | >$1,500 | $5,000 |
| 701-725 | >$750 | $2,500 |
| 675-700 | >$250 | $1,000 |
| 600-674 | — | $350 |

### Terms and Definitions

Unless otherwise defined, all technical and scientific terms used herein have the same meaning as commonly understood by those of ordinary in the art to which this disclosure belongs. The system, methods, and examples provided herein are only illustrative and not intended to be limiting. In the following specification and the claims, reference will be made to a number of terms, which shall be defined to have the following meanings.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, by way of example, near the stated amount by 10%, 5%, or 1%, including increments therein, and by way of further example, greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The terms “comprises,” “comprising,” or any other variations thereof, are intended to cover a non-exclusive inclusion, such that a process or method that comprises a list of steps does not include only those steps but may include other steps not expressly listed or inherent to such a process or method. Similarly, one or more devices or modules or elements or structures or components preceded by “comprises . . . a” does not, without more constraints, preclude the existence of other devices, modules, elements, structures, components, additional devices, additional modules, additional elements, additional structures or additional components. Appearances of the phrase “in an embodiment,” “in another embodiment” and similar language throughout this specification may, but not necessarily do, all refer to the same embodiment.

A computer system (standalone, client or server computer system) configured by an application may constitute a “module” that is configured and operated to perform certain operations. In one embodiment, the “module” may be implemented mechanically or electronically, so a module may comprise dedicated circuitry or logic that is permanently configured (within a special-purpose processor) to perform certain operations. In another embodiment, a “module” may also comprise programmable logic or circuitry (as encompassed within a general purpose processor or other programmable processor) that is temporarily configured by software to perform certain operations.

Accordingly, the term “module” should be understood to encompass a tangible entity, be that an entity that is physically constructed permanently configured (hardwired) or temporarily configured (programmed) to operate in a certain manner and/or to perform certain operations described herein.

### Computing Systems

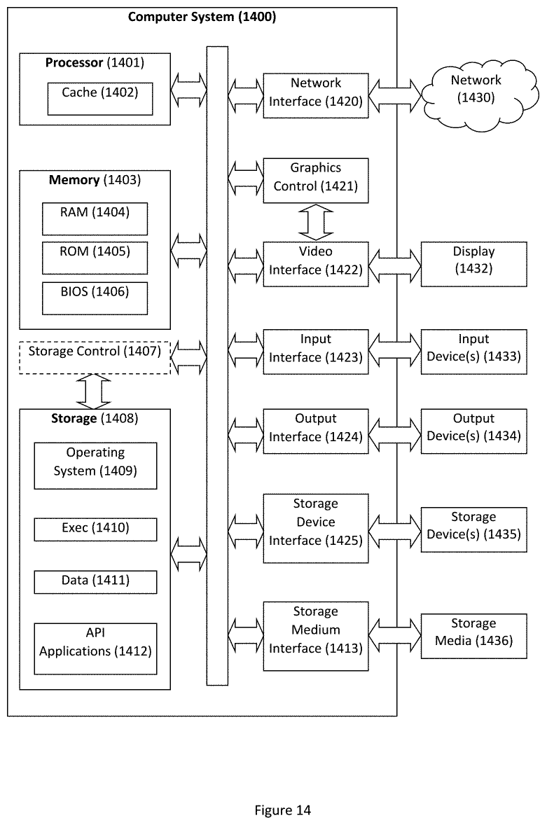

Referring to FIG. 14, a block diagram is shown depicting an exemplary machine that comprises a computer system 1400 (e.g., a processing or computing system) within which a set of instructions can execute for causing a device to perform or execute any one or more of the aspects and/or methodologies for static code scheduling of the present disclosure. The components in FIG. 14 are examples only and do not limit the scope of use or functionality of any hardware, software, embedded logic component, or a combination of two or more such components implementing particular embodiments.

Computer system 1400 may include one or more processors 1401, a memory 1403, and a storage 1408 that communicate with each other, and with other components, via a bus 1440. The bus 1440 may also link a display 1432, one or more input devices 1433 (which may, for example, include a keypad, a keyboard, a mouse, a stylus, etc.), one or more output devices 1434, one or more storage devices 1435, and various tangible storage media 1436. All of these elements may interface directly or via one or more interfaces or adaptors to the bus 1440. For instance, the various tangible storage media 1436 can interface with the bus 1440 via storage medium interface 1426. Computer system 1400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1400 comprises one or more processor(s) 1401 (e.g., central processing units (CPUs) or general purpose graphics processing units (GPGPUs)) that carry out functions. Processor(s) 1401 optionally contains a cache memory unit 1402 for temporary local storage of instructions, data, or computer addresses. Processor(s) 1401 are configured to assist in execution of computer readable instructions. Computer system 1400 may provide functionality for the components depicted in FIG. 14 as a result of the processor(s) 1401 executing non-transitory, processor-executable instructions embodied in one or more tangible computer-readable storage media, such as memory 1403, storage 1408, storage devices 1435, and/or storage medium 1436. The computer-readable media may store software that implements particular embodiments, and processor(s) 1401 may execute the software. Memory 1403 may read the software from one or more other computer-readable media (such as mass storage device(s) 1435, 1436) or from one or more other sources through a suitable interface, such as network interface 1420. The software may cause processor(s) 1401 to carry out one or more processes or one or more steps of one or more processes described or illustrated herein. Carrying out such processes or steps may include defining data structures stored in memory 1403 and modifying the data structures as directed by the software.

The memory 1403 may include various components (e.g., machine readable media) including, but not limited to, a random access memory component (e.g., RAM 1404) (e.g., static RAM (SRAM), dynamic RAM (DRAM), ferroelectric random access memory (FRAM), phase-change random access memory (PRAM), etc.), a read-only memory component (e.g., ROM 1405), and any combinations thereof. ROM 1405 may act to communicate data and instructions unidirectionally to processor(s) 1401, and RAM 1404 may act to communicate data and instructions bidirectionally with processor(s) 1401. ROM 1405 and RAM 1404 may include any suitable tangible computer-readable media described below. In one example, a basic input/output system 1406 (BIOS), including basic routines that help to transfer information between elements within computer system 1400, such as during start-up, may be stored in the memory 1403.

Fixed storage 1408 is connected bidirectionally to processor(s) 1401, optionally through storage control unit 1407. Fixed storage 1408 provides additional data storage capacity and may also include any suitable tangible computer-readable media described herein. Storage 1408 may be used to store operating system 1409, executable(s) 1410, data 1411, applications 1412 (application programs), and the like. Storage 1408 can also include an optical disk drive, a solid-state memory device (e.g., flash-based systems), or a combination of any of the above. Information in storage 1408 may, in appropriate cases, be incorporated as virtual memory in memory 1403.

In one example, storage device(s) 1435 may be removably interfaced with computer system 1400 (e.g., via an external port connector (not shown)) via a storage device interface 1425. Particularly, storage device(s) 1435 and an associated machine-readable medium may provide non-volatile and/or volatile storage of machine-readable instructions, data structures, program modules, and/or other data for the computer system 1400. In one example, software may reside, completely or partially, within a machine-readable medium on storage device(s) 1435. In another example, software may reside, completely or partially, within processor(s) 1401.

Bus 1440 connects a wide variety of modules. Herein, reference to a bus may encompass one or more digital signal lines serving a common function, where appropriate. Bus 1440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1400 may also include an input device 1433. In one example, a user of computer system 1400 may enter commands and/or other information into computer system 1400 via input device(s) 1433. Examples of an input device(s) 1433 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1433 may be interfaced to bus 1440 via any of a variety of input interfaces 1423 (e.g., input interface 1423) including, but not limited to, serial, parallel, game port, USB, FIREWIRE, THUNDERBOLT, or any combination of the above.

In particular embodiments, when computer system 1400 is connected to network 1430, computer system 1400 may communicate with other devices, specifically mobile devices and enterprise systems, distributed computing systems, cloud storage systems, cloud computing systems, and the like, connected to network 1430. Communications to and from computer system 1400 may be sent through network interface 1420. For example, network interface 1420 may receive incoming communications (such as requests or responses from other devices) in the form of one or more packets (such as Internet Protocol (IP) packets) from network 1430, and computer system 1400 may store the incoming communications in memory 1403 for processing. Computer system 1400 may similarly store outgoing communications (such as requests or responses to other devices) in the form of one or more packets in memory 1403 and communicated to network 1430 from network interface 1420. Processor(s) 1401 may access these communication packets stored in memory 1403 for processing.

Examples of the network interface 1420 include, but are not limited to, a network interface card, a modem, and any combination thereof. Examples of a network 1430 or network segment 1430 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1430, may employ a wired and/or a wireless mode of communication. In general, any network topology may be used.

Information and data can be displayed through a display 1432. Examples of a display 1432 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1432 can interface to the processor(s) 1401, memory 1403, and fixed storage 1408, as well as other devices, such as input device(s) 1433, via the bus 1440. The display 1432 is linked to the bus 1440 via a video interface 1422, and transport of data between the display 1432 and the bus 1440 can be controlled via the graphics control 1421. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1432, computer system 1400 may include one or more other peripheral output devices 1434 including, but not limited to, an audio speaker, a printer, a storage device, and any combinations thereof. Such peripheral output devices may be connected to the bus 1440 via an output interface 1424. Examples of an output interface 1424 include, but are not limited to, a serial port, a parallel connection, a USB port, a FIREWIRE port, a THUNDERBOLT port, and any combinations thereof.

In addition or as an alternative, computer system 1400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Applications

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

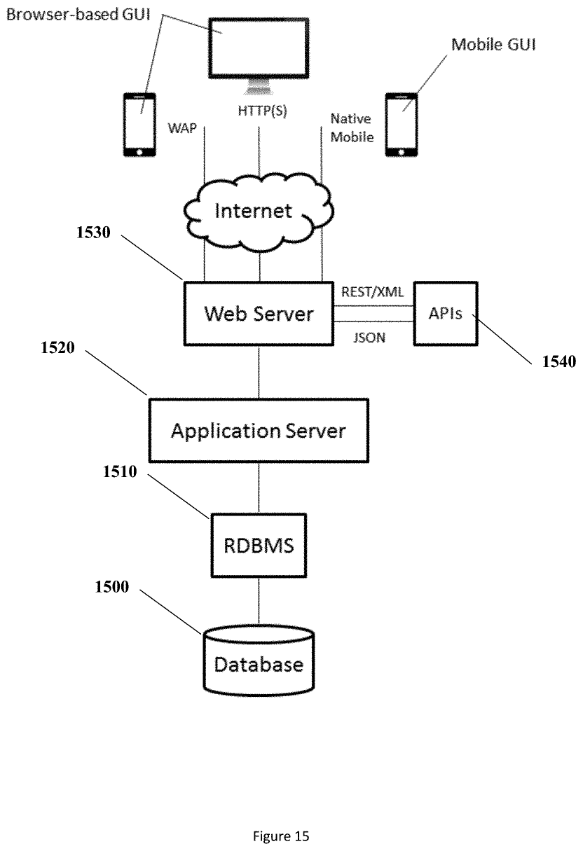

Referring to FIG. 15, in a particular embodiment, an application provision system comprises one or more databases 1500 accessed by a relational database management system (RDBMS) 1510. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 1520 (such as Java servers, .NET servers, PHP servers, and the like) and one or more web servers 1530 (such as Apache, IIS, GWS and the like). The web server(s) optionally expose one or more web services via app application programming interfaces (APIs) 1540. Via a network, such as the Internet, the system provides browser-based and/or mobile native user interfaces.

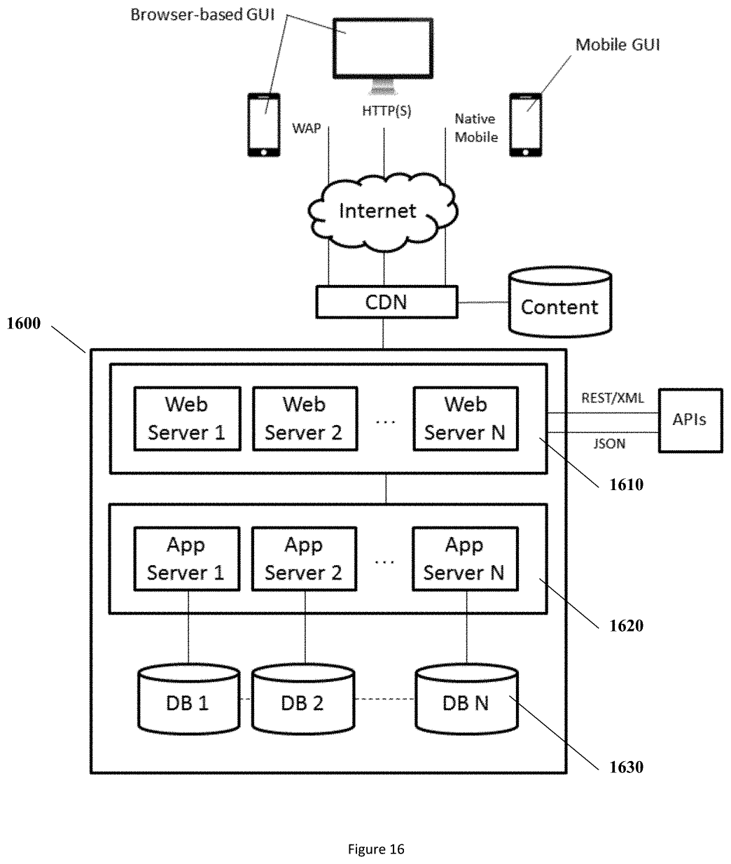

Referring to FIG. 16, in a particular embodiment, an application provision system alternatively has a distributed, cloud-based architecture 1600 and comprises elastically load balanced, auto-scaling web server resources 1610 and application server resources 1620 as well synchronously replicated databases 1630.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of donor, NPO, donation, bank, or funding information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of the software applications, systems, and methods described herein and are not meant to be limiting in any way.

### Example 1

FIG. 3 is a block diagram illustrating an exemplary system 10 for facilitating charitable donations in accordance with an embodiment of the present disclosure. In some embodiments, the exemplary system 10 shows how a donor X 60 uses the system 10 to donate $500 to United Nations International Children's Emergency Fund (UNICEF) 70. In some embodiments, the system first registers via an organization registration module 20 the UNICEF 70 organization as a client. For registration it records every details of UNICEF 70. Details such as field of children working domain, the organization current working project and the like.

A donation page for UNICEF 70 current on-going project is created by the system 10 via a donation integration module 30. In some embodiments, the page is customized according to the need of the organization. In some embodiments, then the page is integrated with the system 10 for facilitating donation for individual doners. In some embodiments, the donor X 60 donates to any chosen amount by just clicking the donate button. In some embodiments, the donor X 60 donates $100 to the UNICEF 70 current on-going project.

A message pops up saying “thank you for your generous donation which will feed a child for a month—please consider donating an extra $500 to feed a family.” To facilitate the system 10 may provide loan facilities. In some embodiments, the system 10 via a donor registration module 40, enables the donor X 60 to apply for a loan to donate. In some embodiments, the donor registration module 40 first registers the specific loan availing donor and routes such donor to third party financial lending sites giving such type of loans. In some embodiments, the third-party financial lending sites enable the donor X 60 to negotiate and loan the amount for donation.

In another exemplary embodiment, the donor X 60 may be given a provisional line of credit to use on a charity auction bidding site. This process is specific to charity biddings. If any client is about to bid on any item, the system 10 allows opportunity to apply for a loan upon proper negotiation. In some embodiments, the donor X 60 may bid up to that maximum and the successful winning bid will trigger the loan activation and subsequent routing of funds.

In yet another exemplary embodiment, the donor X 60 may agree for monthly donations. Here, rather than donating to a non-profit organization such as UNICEF 70 each month with an automatic subscription, the third-party lenders may pay the whole donation money at one instant. While the donor X 60 pays the lender each month.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented system for donating to a charitable non-profit organization (NPO), the system comprising: a digital processing device comprising: at least one processor and a instructions executable by the at least one processor to provide an application comprising:
(a) an NPO registration module receiving a plurality of details of the NPO;
(b) a donation integration module creating a donation page accessible by the NPO to receive a donation;
(c) a donor registration module receiving an application for a loan to donate to the NPO; and
(d) a loan tracking module, providing a loan notification to the donor.

2. The system of claim 1, wherein the plurality of details comprises an organization name, an organization working domain, an organization slogan, or any combination thereof.

3. The system of claim 1, wherein the donation page comprises a name of the NPO, a working domain of the NPO, a slogan of the NPO, a detail of the NPO, or any combination thereof.

4. The system of claim 1, wherein the application for the loan comprises a donation amount, donation plan selection, a personal data of the donor, a payment information, a payment type, a two-factor donor authentication, or any combination thereof.

5. The system of claim 1, wherein the application further comprises a module transmitting data between the donation integration module and the donor registration module.

6. The system of claim 1, wherein the donor registration module further verifies an identification of the donor.

7. The system of claim 1, wherein the loan notification comprises a notification of loan payment, loan approval, loan rejection, fund transfers, tax donation receipts, or any combination thereof.

8. The system of claim 1, wherein the loan tracking module further provides the loan notification to the NPO.

9. The system of claim 8, wherein the loan tracking module further tokenizes the loan notification, and sends the tokenized notification to the NPO.

10. The system of claim 1, wherein the loan tracking module further transmits the donor information, a parameter of the loan, or both to a system of record.

11. A computer-implemented method of comprising:
(a) receiving, from a donor, a donor information and a donation amount to a non-profit organization (NPO);
(b) performing, by an integrated decision engine, a fraud and credit risk assessment, wherein:
(i) if the fraud and credit risk assessment is declined:
I) transmitting a notification to the donor of the fraud and credit risk assessment decline;
II) directing the donor to an NPO donation form; and
III) appending the fraud and credit risk assessment decline to the donor information; and
(ii) if the fraud and credit risk assessment is approved: transmitting a notification to the donor of the fraud and credit risk assessment approval;
(c) transmitting, to the donor receiving the fraud and credit risk assessment approval, a loan plan;
(d) generating an approved loan based upon the loan plan upon receipt of the donor's approval of the loan plan; and
(e) transmitting the donor information and the approved loan to a system of record.

12. The method of claim 11, wherein the donor information comprises a donation amount, donation plan selection, a personal data, a payment information, a payment type, a two-factor donor authentication, or any combination thereof.

13. The method of claim 11, further comprising transmitting a notification to the NPO based on the loan.

14. The method of claim 11, further comprising providing a verification code to the donor and receiving the verification code from the donor to validate the donor.

15. The method of claim 11, further comprising:
(a) requesting, by the system of record, a fund from a lender denoted in the approved loan plan;
(b) receiving, by the system of record, a current status of the approved loan plan from the lender; or
(c) both.

16. The method of claim 15, further comprising providing the loan plan amount to the NPO.

17. The method of claim 11, further comprising tokenizing the donor information, the approved loan, or both before step (e), and wherein the tokenized donor information, the tokenized approved loan, or both are sent to the system of record.

18. The method of claim 11, further comprising:
(a) receiving, from the donor, a rejection of the loan plan; and
(b) transmitting, to the donor, an alternative loan plan, wherein if:
(i) the donor approves the alternative loan plan, the approved loan is generated based on the alternative loan plan; and
(ii) the donor rejects the alternative loan plan, directing the donor to an NPO donation form.
